(19) United States
(12) Patent Application Publication
(10) Pub. No.: US 2005/0018222 A1
(43) Pub. Date: Jan. 27, 2005

(54) Printing control apparatus, printing control method, and printing control program product

(76) Inventor: Seishin Yoshida, Nagano (JP)

Correspondence Address: MARTINE & PENILLA, LLP, 710 LAKEWAY DRIVE, SUITE 170, SUNNYVALE, CA, 94085, US

(21) Appl. No.: 10/859,425

(22) Filed: Jun. 1, 2004

(30) Foreign Application Priority Data
Jun. 2, 2003 (JP) 2003-156610

(51) Int. Cl. G06F 15/00; B41J 2/21

(52) U.S. Cl. 358/1.9; 358/1.7

(57) ABSTRACT

An object of the present invention is to improve the image quality so as to effectively prevent banding and keep dot granularity unremarkable. A print condition specified for image data is acquired from a plurality of print conditions provided as influencing the possibility of banding on a printout produced by a printer (printing apparatus). There is provided a plurality of color conversion modes having modified usage ratios between chromatic inks and LLk ink (second light black ink). The image data is color-converted in a color conversion mode corresponding to the acquired print condition out of those color conversion modes. The printer is controlled so as to print an image corresponding to the color-converted image data. The printer produces a printout of the image at the usage ratio between the chromatic inks and the LLk ink. At this time, the usage ratio is modified according to a print condition that affects the possibility of banding. Consequently, the excellent image quality becomes available so as to stabilize the gray balance by preventing banding and keeping dot granularity unremarkable.

### BACKGROUND OF THE INVENTION

1. Field of the Invention

The present invention relates to a printing control apparatus, a printing control method, and a printing control program product to provide printing control for a printing apparatus capable of printing by using chromatic inks and light black inks.

2. Description of Related Art

When an image is printed on a printer having a plurality of color inks, it has been a conventional practice to form dots by replacing part or all of chromatic inks such as cyan (C), magenta (M), and yellow (Y) inks with a dark gray ink (also referred to as an achromatic ink) such as black (K) ink. Further, as disclosed in patent documents 1 and 2, a printer may be provided with light black inks (Lk or LLk) having smaller depths than the K ink. There has been another conventional practice to form dots by replacing part or all of light cyan (Lc), light magenta (Lm), and Y inks with Lk or LLk ink. A printing control apparatus provides print control for the printer. To do this, the printing control apparatus inputs image data, references a color conversion table, and converts the colors into image data corresponding to each of a plurality of inks. This can decrease influences such as variations in the ink ejection amounts of various chromatic inks to improve the gray balance and the like.

Patent document: See JP-A No. 2001-277552.

Patent document: See JP-A No. 2002-331693.

The above-mentioned prior art causes the following problems.

That is to say, replacing various chromatic inks with the dark gray ink decreases dots of ink formed on a medium such as printout paper, easily causing a striped irregularity called banding. Further, the dot granularity may become remarkable since the ink to be used becomes dense.

### SUMMARY OF THE INVENTION

The present invention has been made in consideration of the foregoing. It is therefore an object of the present invention to provide a printing control apparatus, a printing control method, and a printing control program product capable of acquiring images of excellent image quality so as to stabilize the gray balance by preventing banding and keeping dot granularity unremarkable.

To achieve the above-mentioned object, the present invention according to claim 1 provides a printing control apparatus which performs printing control for a printing apparatus capable of printing through the use of a plurality of inks containing chromatic inks and at least one light black ink. The printing control apparatus comprises a printing condition acquirer, a color converter, and a printing controller. The printing control apparatus receives image data representing an image with gradation data comprising many pixels and performs color conversion into image data corresponding to each of the plurality of inks for the printing apparatus to provide printing control.

The printing condition acquirer acquires a print condition specified for the image data. There is provided a plurality of color conversion modes having different usage ratios between the chromatic ink and the light black ink. The color converter color-converts the image data using a color conversion mode which belongs to these color conversion modes and corresponds to a print condition acquired by the printing condition acquirer. In other words, the color converter color-converts the input image data into image data corresponding to each of the inks so as to change the usage ratio between the chromatic ink and the light black ink in accordance with the acquired print condition.

The printing controller provides control so that the printing apparatus prints an image based on and corresponding to the color-converted image data. The printing apparatus then produces a printout of the image using the chromatic ink and the light black ink at the usage ratio changed by the color conversion mode corresponding to the print condition.

Accordingly, if there is provided a plurality of color conversion modes having modified usage ratios between chromatic ink and light black ink so as to prevent banding, it is possible to produce images with excellent image quality by preventing the banding. If the usage ratio of light black ink is increased, the light black ink indicates a relatively small depth in dark gray inks. If the chromatic ink is replaced by the light black ink to decrease dots, the dot granularity becomes unremarkable.

The light black ink may comprise a first light black ink and a second light black ink having a smaller depth than the first light black ink. In this case, the dot granularity becomes more unremarkable by increasing the usage ratio of the second light black ink having the relatively smaller depth out of the first and second light black inks.

In this manner, the present invention makes it possible to acquire images of excellent image quality so as to stabilize the gray balance by preventing banding and keeping dot granularity unremarkable.

The printing control apparatus according to claim 2 has a plurality of predetermined print conditions which are provided as influencing possibility of banding on a printout produced by the printing apparatus. The printing condition acquirer acquires a print condition specified for the image data out of those print conditions.

The printing controller provides control for the printing apparatus to print an image based on and corresponding to the color-converted image data. The printing apparatus then produces a printout of the image using the chromatic ink and the light black ink at the usage ratio changed by the color conversion mode corresponding to the print condition which affects the possibility of banding.

Accordingly, if there is provided a plurality of color conversion modes having modified usage ratios between chromatic ink and light black ink so as to prevent banding, it is possible to produce images with excellent image quality by preventing the banding. If the chromatic ink is replaced by the light black ink to decrease dots, the dot granularity becomes unremarkable. The dot granularity becomes more unremarkable by increasing the usage ratio of the second light black ink having the relatively smaller depth out of the first and second light black inks. In this manner, it becomes possible to acquire images of excellent image quality so as to stabilize the gray balance by preventing banding and keeping dot granularity unremarkable.

The print conditions according to the present invention just need to influence the possibility of banding on a printout produced by the printing apparatus. As will be discussed below, the print conditions may include pass counts for printing a line of image, media types, print resolutions, print dot sizes, and the like.

The printing apparatus includes an apparatus that uses a plurality of light black inks having different depths. Of these light black inks, the one having a smaller depth can be defined to be the second light black ink. The printing apparatus also includes an apparatus capable of printing by using ink containing dark gray ink having a larger depth than the first light black ink.

It is assumed that the light black ink comprises a first light black ink and a second light black ink having a smaller depth than the first light black ink. The color converter sequentially color-converts gradation data of pixels constituting the image data. When a gradation amount represents achromatic components of the pixels to be color-converted, the gradation amount may belong to the high-brightness side from a specified reference amount. In this case, the color conversion may be configured to use only the second light black ink out of both light black inks. When achromatic components of the target pixel belong to the high-brightness side from a specified amount, the apparatus uses only the second light black ink having a relatively small depth. This makes it more reliably possible to acquire images of excellent image quality so as to stabilize the gray balance by preventing banding and keeping dot granularity unremarkable.

It is also assumed that the light black ink comprises the first light black ink and the second light black ink. The color converter sequentially color-converts gradation data of pixels constituting the image data. When a gradation amount represents achromatic components of the pixels to be color-converted, the gradation amount may belong to the low-brightness side from a specified reference amount. In this case, the color conversion may be configured to use only the first light black ink out of both light black inks. When achromatic components of the target pixel belong to the low-brightness side from a specified amount, the apparatus uses only the first light black ink having a relatively large depth. It is possible to excellently represent the low-brightness area as a dark portion in the image, making it possible to acquire images of more excellent image quality.

A numeric value or any other information may be used for the gradation amount which represents achromatic components of the pixels to be color-converted. The gradation amount can be found from a color component amount of each element color in an image represented by the image data. The gradation amount can represent a maximum, a minimum, an average, and the like of color component values for each element color. The above-mentioned reference amount may vary with the color component amount for each element color or may be fixed independently of differences in color component amounts for the respective element colors.

Further, there may be provided a plurality of color conversion modes having modified usage ratios between chromatic ink and light black ink. In such case, the color converter may color-convert the image data using a color conversion mode which belongs to those color conversion modes and corresponds to the print condition acquired by the printing condition acquirer. The printing apparatus then produces a printout of the image using the first and second light black inks at the modified usage ratio corresponding to the print condition influencing the possibility of banding. That is to say, if there is provided a plurality of color conversion modes having modified usage ratios between chromatic ink and light black ink so as to prevent banding, it is possible to provide excellent image quality by preventing the banding. If the usage ratio of light black ink is increased, the light black ink indicates a relatively small depth in dark gray inks, making the dot granularity unremarkable. Consequently, it becomes possible to acquire images of excellent image quality so as to stabilize the gray balance by preventing banding and keeping dot granularity unremarkable.

Of course, there may be provided a plurality of color conversion modes having modified usage ratios between the chromatic ink and only the second light black ink out of the first and second light black inks. The image data may be color-converted using a color conversion mode selected from those color conversion modes. In a plurality of inks, this can increase the usage ratio of the second light black ink having a relatively small depth out of the first and second light black inks. It becomes possible to acquire images of excellent image quality so as to stabilize the gray balance by preventing banding and keeping dot granularity more unremarkable.

There may be provided a plurality of color conversion modes having modified usage ratios between the chromatic inks and the light black inks only in a specified high-brightness area of the color space capable of color conversion. Of these color conversion modes, the color converter may use a color conversion mode corresponding to the print condition acquired by the printing condition acquirer to color-convert the image data. When the chromatic inks are replaced by the light black ink, banding easily occurs in a high-brightness area. Accordingly, it becomes possible to acquire images of excellent image quality so as to stabilize the gray balance by preventing banding and keeping dot granularity unremarkable when replacing the chromatic inks with the light black ink.

As an example of the print condition, there may be a case where the printing apparatus prints a line of image corresponding to the image data using a pass count selected from a plurality of types of pass counts. In this case, the pass count specified for the image data is acquired as the print condition. The color converter color-converts the input image data into image data corresponding to each of the inks so as to change the usage ratio between the chromatic ink and the light black ink. At this time, the color converter uses a color conversion mode corresponding to the pass count specified for the image data out of a plurality of color conversion modes provided correspondingly to the pass counts. The printing apparatus then produces a printout of the image at the modified ink usage ratio corresponding to the specified pass count. Consequently, it becomes possible to acquire images of excellent image quality so as to stabilize the gray balance by preventing banding and keeping dot granularity unremarkable in accordance with the pass count.

To give an actual example, the color converter may be configured to increase a usage ratio of the light black ink as the pass count increases. Generally, increasing the pass count decreases the possibility of banding, making it possible to give a preference to the gray balance. It becomes possible to increase the usage ratio of the light black ink and produce an image with optimum image quality and less remarkable granularity of dots.

As another example, there is provided a plurality of types of media capable of printing an image corresponding to the image data. Of these media types, a media type specified for the image data is acquired as the print condition. The color converter color-converts the input image data into image data corresponding to each of the inks so as to change the usage ratio between the chromatic ink and the light black ink. At this time, the color converter uses a color conversion mode corresponding to the media type acquired as the print condition out of a plurality of color conversion modes provided correspondingly to the media types. The printing apparatus then produces a printout of the image at the modified ink usage ratio corresponding to the acquired media type. Consequently, it becomes possible to acquire images of excellent image quality so as to stabilize the gray balance by preventing banding and keeping dot granularity unremarkable in accordance with the media type.

To give an actual example, the color converter may be configured to increase a usage ratio of the light black ink when a diameter of an ink dot formed on the media is larger than a vertical scanning interval of the printing apparatus and the media type causes a relatively large diameter of an ink dot formed in the same ejection amount. It is assumed that a dot diameter is larger than the vertical scanning interval. With the ejection amount unchanged, increasing the diameter of ink dots formed on the medium generally decreases the possibility of banding, making it possible to give a preference to the gray balance. It becomes possible to increase the usage ratio of the light black ink and produce images of excellent image quality so as to stabilize the gray balance by keeping dot granularity unremarkable.

As still another example, the printing apparatus prints an image corresponding to the image data at a resolution selected from a plurality of types of resolutions. In this case, the resolution specified for the image data is acquired as the print condition. The color converter color-converts the input image data into image data corresponding to each of the inks so as to change the usage ratio between the chromatic ink and the light black ink. At this time, the color converter uses a color conversion mode corresponding to the resolution specified for the printing apparatus out of a plurality of color conversion modes provided correspondingly to the resolutions. The printing apparatus then produces a printout of the image at the modified ink usage ratio corresponding to the specified resolution. Consequently, it becomes possible to acquire images of appropriate image quality so as to stabilize the gray balance by preventing banding and keeping dot granularity unremarkable in accordance with the resolution.

To give an actual example, the color converter may be configured to increase a usage ratio of the light black ink as the resolution increases. Generally, increasing the resolution enhances the degree of freedom to dispose dots and decreases the possibility of banding. That is to say, increasing the resolution makes it possible to give a preference to the gray balance. It becomes possible to increase the usage ratio of the light black ink and produce images of optimum image quality by keeping dot granularity unremarkable.

As yet another example, the printing apparatus prints an image corresponding to the image data using the plurality of inks in a dot size selected from a plurality of types of dot sizes. In this case, a dot size specified for the image data is acquired as the print condition. The color converter color-converts the input image data into image data corresponding to each of the inks so as to change the usage ratio between the chromatic ink and the light black ink. At this time, the color converter uses a color conversion mode corresponding to the dot size specified for the printing apparatus out of a plurality of color conversion modes provided correspondingly to the dot sizes. The printing apparatus then produces a printout of the image at the modified ink usage ratio corresponding to the specified dot size. Consequently, it becomes possible to acquire images of appropriate image quality so as to stabilize the gray balance by preventing banding and keeping dot granularity unremarkable in accordance with the dot size.

To give an actual example, the color converter may be configured to increase a usage ratio of the light black ink as the dot size increases when a diameter of an ink dot formed on the media is larger than a vertical scanning interval of the printing apparatus. Generally, increasing the resolution enhances the degree of freedom to dispose dots and decreases the possibility of banding. That is to say, it is assumed that the diameter of ink dots formed on media is larger than the vertical scanning interval. Generally, increasing the dot size decreases the possibility of banding, making it possible to give a preference to the gray balance. It becomes possible to increase the usage ratio of the light black ink and produce images of optimum image quality by keeping dot granularity unremarkable.

As still yet another example, there may be provided a plurality of color conversion tables which specify correspondence between image data before and after the color conversion according to the print conditions. The color converter may be configured to color-convert input image data by referencing a color conversion table corresponding to the print condition out of those color conversion tables. That is to say, the input image data is color-converted for each print condition according to the color conversion table corresponding to the print condition influencing the possibility of banding. Accordingly, the color conversion tables are provided for respective print conditions so that the usage ratio between the chromatic ink and the light black ink can be changed to prevent banding. In this manner, the color conversion can be performed to provide an optimum ink usage ratio in accordance with the print condition. It becomes possible to acquire images of excellent image quality so as to stabilize the gray balance by preventing banding and keeping dot granularity unremarkable.

In addition to the color conversion tables, for example, it may be preferable to provide a plurality of conversion formulas which convert the correspondence between image data before and after the color conversion. The image data may be color-converted using a conversion formula out of these conversion formulas.

The above-mentioned chromatic inks may comprise low-saturation cyan ink, low-saturation magenta ink, and high-saturation yellow ink. The use of the low-saturation cyan and magenta inks relatively increases the usage of the chromatic inks. Increasing the usage ratio of the light black inks can produce an image with more excellent image quality by preventing the banding.

The above-mentioned printing control apparatus may be embodied independently or may be included in a given device and embodied with other methods. The idea of the invention includes various embodiments and can be modified appropriately.

The processes can follow a specified procedure corresponding to each of the above-mentioned means. Consequently, the present invention can be also embodied as the control method and provides basically the same effects.

Further, the present invention can be embodied as a print system comprising print means for printing by using the plurality of inks and provides basically the same effects.

When embodying the present invention, the printing control apparatus may execute a specified control program. Accordingly, the present invention can be embodied as a program product and provides basically the same effects. The program product can be recorded on a medium which can be distributed. The program product can be read into a computer as needed from the recording medium. The present invention can be embodied as the medium recording the program product and provides basically the same effects. The recording medium may be not only a magnetic or magneto-optical medium, but also any recording medium to be developed in the future. The present invention is not limited to reproduction stages such as primary or secondary reproductions. The idea of the present invention includes a partial embodiment on hardware or recording part of the present invention on a recording medium and reading it as needed.

It is to be distinctly understood that the above-mentioned various changes and modifications can be made applicable to the above-mentioned method, the print system, the program product, and the medium recording the program product.

### BRIEF DESCRIPTION OF THE DRAWINGS

FIG. 1 is a schematic block diagram of a print system according to a first embodiment of the present invention;

FIG. 2 shows a printer block diagram together wit a PC;

FIG. 3 schematically shows the number of passes (pass count) to print one line of an image;

FIG. 4 schematically shows resolutions to print images;

FIG. 5 shows relationship between a voltage difference in drive signals and an ink dot size;

FIG. 6 schematically shows an overview configuration of the printing control apparatus;

FIG. 7 exemplifies correspondence provided by an LUT in a gray level;

FIG. 8 shows an example of providing an LUT for each printing condition;

FIG. 9 is a flowchart showing a printing control process;

FIG. 10 shows relationship between the possibility of banding and a usage ratio of LkLLk ink;

FIG. 11 exemplifies correspondences provided by a plurality of LUTs in the gray level;

FIG. 12 illustrates a difference in dot granularities between K and LLk inks;

FIG. 13 schematically shows diameters of dots formed on media viewed from the sections;

FIG. 14 schematically shows a difference of dots formed on different types of media;

FIG. 15 exemplifies correspondences provided by a plurality of LUTs in the gray level according to a second embodiment;

FIG. 16 schematically shows a high-brightness area in the RGB color space;

FIG. 17 exemplifies correspondences provided by a plurality of LUTs in the gray level according to a modification;

FIG. 18 is a flowchart showing a color conversion process performed by the printing control apparatus according to a third embodiment; and

FIG. 19 shows conversion factors provided for respective printing conditions.

### DETAILED DESCRIPTION OF THE PREFERRED EMBODIMENTS

Embodiments of the present invention will be described according to the following sequence.

(1) Printing system configuration

(2) Configuration overview of the printing control apparatus

(3) Detailed processes of the printing control apparatus

(4) Second embodiment

(5) Third embodiment

(1) Printing System Configuration

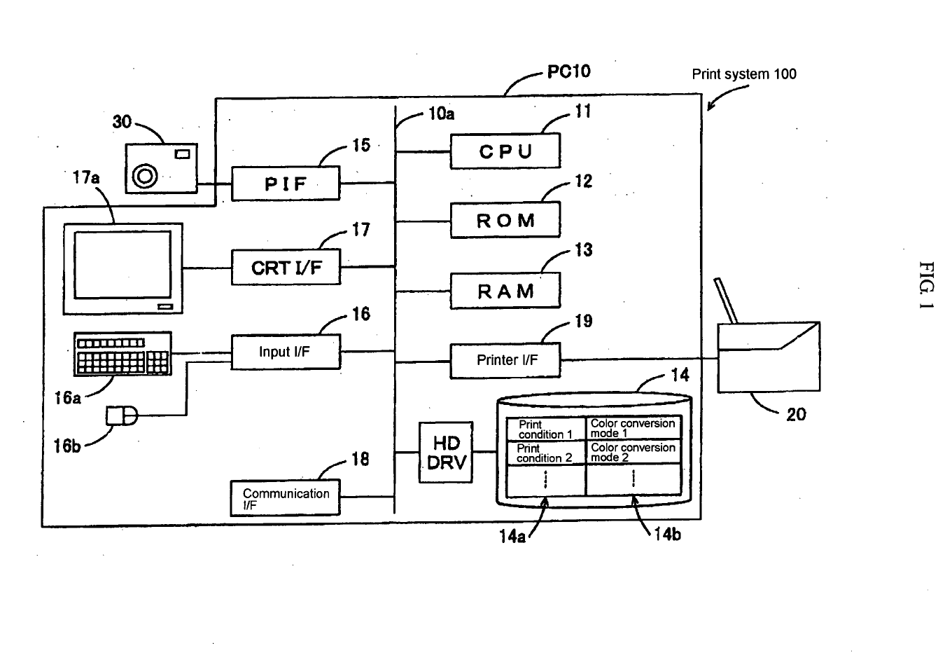

FIG. 1 schematically shows the configuration of a print system 100 comprising the printing control apparatus according to the first embodiment of the present invention and peripheral devices. The system 100 comprises a personal computer (PC) 10 functioning as the printing control apparatus according to the present invention, an ink jet printer 20 functioning as the printing apparatus capable of color printing, a digital camera 30, and the like.

In the PC 10, a CPU 11 forms the nucleus of operational processes and controls the whole PC via a system bus 10a. The system bus 10a is connected to ROM 12, RAM 13, various interfaces (I/Fs) 15 through 19, and the like. A hard disk (HD) 14 is also connected to the bus 10a via a hard disk driver (HDDRV). Storage means according to the present invention comprises the hard disk driver HDDRV and the HD 14. The computer used for the present invention may have the general configuration as a computer such as a desktop PC, a notebook PC, and a mobile PC, and is not limited to PCs.

The HD 14 stores an operating system (OS), an application program (APL) capable of creating image information, and the like. The CPU 11 appropriately transfers these pieces of software to the RAM 13 for execution. The HD 14 stores a plurality of print conditions 14a and a plurality of color conversion modes 14b correspondingly to the print conditions 14a.

A peripheral I/F (PIF) 15 is connected to the digital camera 30, a color scanner (not shown), and the like. An input I/F 16 is connected to a keyboard 16a and a mouse 16b as input devices for manipulation. A CRT I/F 17 is connected to a display 17a for monitoring. A printer I/F 19 is connected to a printer 20. The printer 20 is applicable to various connection modes such as a parallel I/F, a serial I/F, and the like.

The HD 14 functions as a medium that records a printing control program according to the present invention. The program may be recorded on the other media such as a CD-ROM, a flexible disk, an optical magnetic disk, nonvolatile memory, and the like. The bus 10a is also connected to a communication I/F 18 such as a modem. Connecting the communication I/F 18 to the Internet network makes it possible to access a specified server and download the printing control program.

The printer 20 according to the embodiment uses chromatic inks and dark gray inks. The chromatic inks include five types such as high-saturation cyan (C), magenta (M), and yellow (Y), and low-saturation light cyan (Lc) and light magenta (Lm). The dark gray inks include three types such as black (K), light black (Lk) as a first light black ink, and light light black (LLk) as a second light black ink. On the specification and the drawings, the ink colors are simply represented as C, M, Y, Lc, Lm, K, Lk, and LLk.

The Lk ink just needs to have a smaller depth than the K ink and can be, for example, 1/10 to ½ as deep as the K ink. The LLk ink just needs to have a smaller depth than the Lk ink and can be, for example, 1/10 to ½ as deep as the Lk ink.

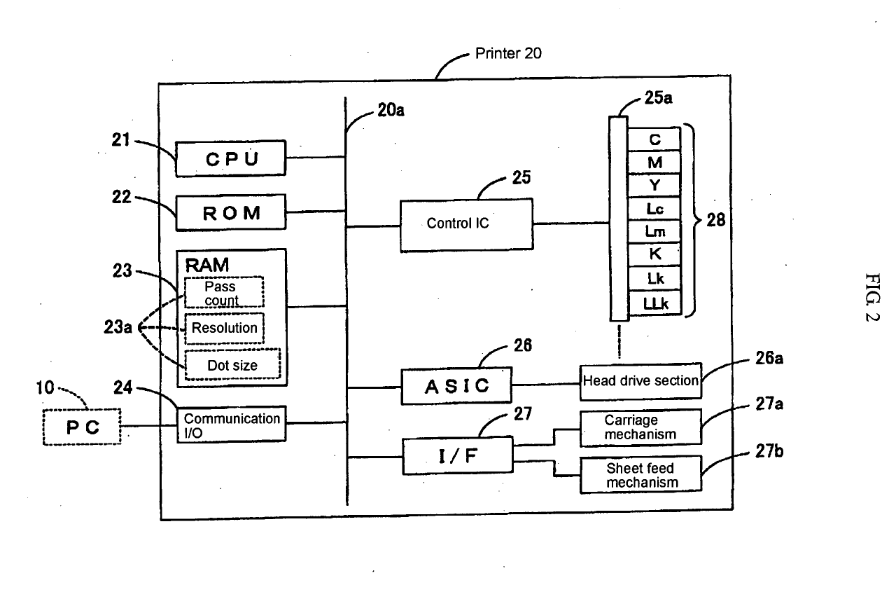

FIG. 2 shows a block configuration of the printer 20 along with the PC 10. The printer 20 functions as print means for printout using eight types of inks based on image data after the color conversion. The printer 20 contains a bus 20a. The bus 20a is connected to not only a CPU 21 to control each part, but also ROM 22, RAM 23, a communication I/O 24, a control IC 25, an ASIC 26, and an I/F 27 to transmit image data, drive signals, and the like.

The control IC 25 exchanges specified signals with the CPU 21 to detect whether or not an ink cartridge 28 is mounted on a cartridge holder 25a, for example. The communication I/O 24 is connected to the printer I/F 19. Via the communication I/O 24, the printer 20 receives data corresponding to each of eight types of ink, print jobs written in a page description language, and the like from the PC 10. When receiving requests from the PC 10, the communication I/O outputs corresponding information to the PC 10. The printer 20 can select the number of passes (pass count) for printing a line of image, the resolution during printing, and the dot size for printing images. The printer 20 acquires selection information about the pass count, the resolution, and the dot size from the PC 10 via the communication I/O 24 and allows the RAM 23 to store selection information 23a. That is to say, storing the selection information 23a can set the pass count, the resolution, and the dot size. The printer 20 can perform printing based on the specified (selected) pass count and the specified (selected) dot size in units of dots corresponding to the resolution.

The ASIC 26 is an IC chip customized to drive a print head (not shown). The ASIC 26 exchanges specified signals with the CPU 21 to perform processes corresponding to the selection information 23a for driving the print head. The ASIC 26 also outputs applied voltage data to a head drive section 26a. The head drive section 26a is a circuit comprising a special IC, a driving transistor, a heat dissipation plate, and the like. The head drive section 26a generates an applied voltage pattern to a piezo actuator built in the print head based on applied voltage data input from the ASIC 26. The print head is connected to the cartridge holder 25a. The print head is supplied with inks from the ink cartridge 28 filled with eight types of different inks. When the piezo actuator is driven, the print head ejects inks to form dots of inks on a medium such as printout paper. Eight rows of nozzles are formed to eject eight types of inks on an ink ejection surface of the print head so as to be aligned with the horizontal scanning direction of the print head. Each nozzle row comprises a plurality of nozzles (e.g., 48 nozzles) that are linearly disposed along the vertical scanning direction at a specified interval.

The I/F 27 is connected to a carriage mechanism 27a and a sheet feed mechanism 27b. The sheet feed mechanism 27b comprises a sheet feed motor, a sheet feed roller, and the like, and sequentially feeds media such as printout paper for vertical scanning. The carriage mechanism 27a comprises a carriage, a carriage motor, and the like. The print head is mounted on the carriage. The carriage motor drives the carriage via a timing belt and the like. The carriage mechanism 27a allows the print head to scan horizontally so that a line of image comprises dots corresponding to the specified pass count. The print head is provided with a plurality of nozzles along the vertical scanning direction. Based on head data comprising bit strings, the head drive section 26a outputs a drive signal to drive the piezo actuator. As a result, the print head ejects ink droplets from each nozzle in units of dots corresponding to the resolution. In this case, an ink droplet conforms to the selected dot size.

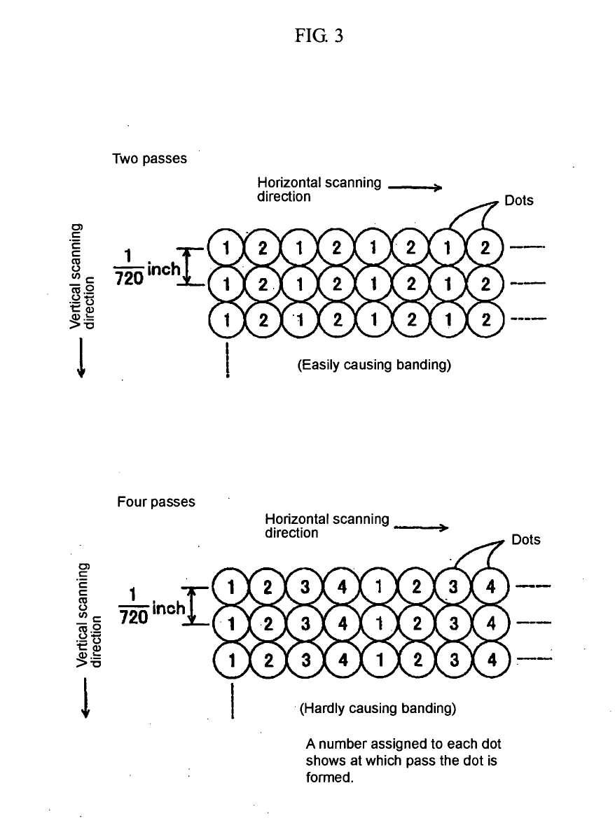

FIG. 3 schematically shows the pass counts for printing one line of image. The printer 20 is capable of printing using pass counts selected from a plurality of types of pass counts. FIG. 3 shows an example of specifying two pass counts, i.e., two passes and four passes. In FIG. 3, a number assigned to each dot shows at which pass the dot is formed. Both modes, i.e., 2-pass and 4-pass, use the print resolution of 1440×720 dpi, the same media type and the same dot size.

In the 2-pass mode as shown in an upper half of FIG. 3, the carriage horizontally scans twice to print a line of dots formed along the horizontal scanning direction. The carriage may horizontally scan twice in the same direction (i.e., unidirectional printing) or in opposite directions (i.e., bidirectional printing). In the 4-pass mode as shown in a lower half of FIG. 3, the carriage horizontally scans four times to print a line of dots formed along the horizontal scanning direction. Of course, the carriage may horizontally scan four times in the same direction or in opposite directions. The ROM 22 stores a control program that allows the head drive section 26a, the carriage mechanism 27a, and the sheet feed mechanism 27b to be driven differently in accordance with pass counts. The CPU 21 reads the selection information about the pass count from the RAM 23 and follows the control program corresponding to the selection information. In this manner, the CPU 21 controls the head drive section 26a, the carriage mechanism 27a, and the sheet feed mechanism 27b via the ASIC 26 and the I/F 27 to print a line of image based on the image data through the specified pass count.

When a pass is changed, the paper is advanced for a specified distance in the vertical scanning direction (sheet feed direction) to print the next pass. That is to say, different nozzles are used to form dots with different numbers on the same row. Accordingly, increasing the pass count also increases the number of nozzles to be used to print a line.

There may be a case where nozzles to print a line contain an erratically ejecting nozzle, i.e., a nozzle causing a deviated ink ejection direction. In such case, a small pass count such as 2-pass is very susceptible to that nozzle and easily causes a striped irregularity called banding. On the other hand, a large pass count such as 4-pass is scarcely susceptible to the nozzle with a misaligned ink ejection direction. Here, it should be noted that, in the following description, LkLLk inks represent Lc, Lm, and Y inks. Likewise, LkLLk inks represent Lk and LLk inks. The number of dots decreases by using much LcLmY inks in comparison with LcLmY inks. Increasing the pass count hardly causes banding. This makes it possible to increase the usage ratio of LkLLk inks. The PC 10 color-converts the image data into image data comprising eight colors CMYKLcLmLkLLk so as to prevent banding in accordance with the pass count specified for the image data.

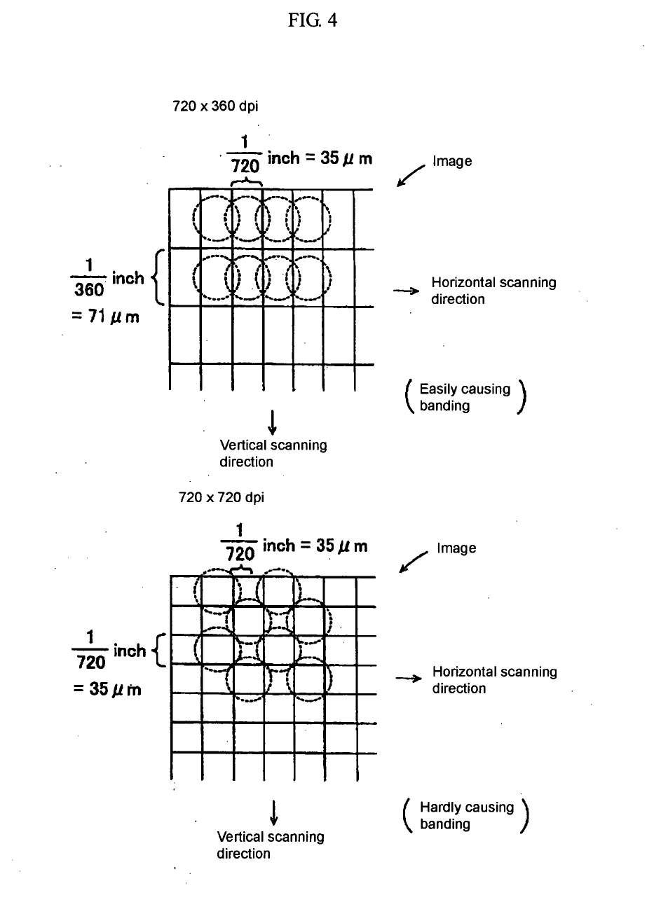

FIG. 4 schematically shows resolutions for printing images. The printer 20 is capable of printing according to resolutions selected from a plurality of resolutions. Three types of resolutions are available, i.e., 720×360 dpi, 720×720 dpi, and 1440×720 dpi. The following describes 720×360 dpi and 720×720 dpi as examples. In FIG. 4, a dotted circle schematically represents a dot formed on the medium. Both resolutions are identical to each other with respect to the other print conditions such as the dot size and the like.

At 720×360 dpi as shown in an upper half of FIG. 4, dots are formed in units of 1/720 inches (=35 mm) in the horizontal scanning direction and in units of 1/360 inches (=71 mm) in the vertical scanning direction. At 720×720 dpi as shown in a lower half of FIG. 4, dots can be formed in units of 1/720 inches in the horizontal scanning direction and the vertical scanning direction. The control program is stored in the ROM 22 in accordance with not only pass counts, but also resolutions. The CPU 21 reads the selection information about resolutions from the RAM 23. The CPU 21 then controls the head drive section 26a, the carriage mechanism 27a, and the sheet feed mechanism 27b in accordance with the control program corresponding to the selection information so as to print an image based on the image data at the specified resolution.

The relatively low resolution 720×360 dpi makes it possible to form only one line of dots within 1/360 inches in the vertical scanning direction. On the other hand, the relatively high resolution 720×720 dpi makes it possible to form two line of dots within 1/360 inches in the vertical scanning direction. That is to say, at a low resolution, an erratically ejecting nozzle, if any, generates striped gaps along the horizontal scanning direction, easily causing the banding. On the other hand, a high resolution enhances the degree of freedom to dispose dots and increases the number of lines of dots disposed in the same interval. Therefore, no striped gaps occur even if there is an erratically ejecting nozzle, hardly causing the banding.

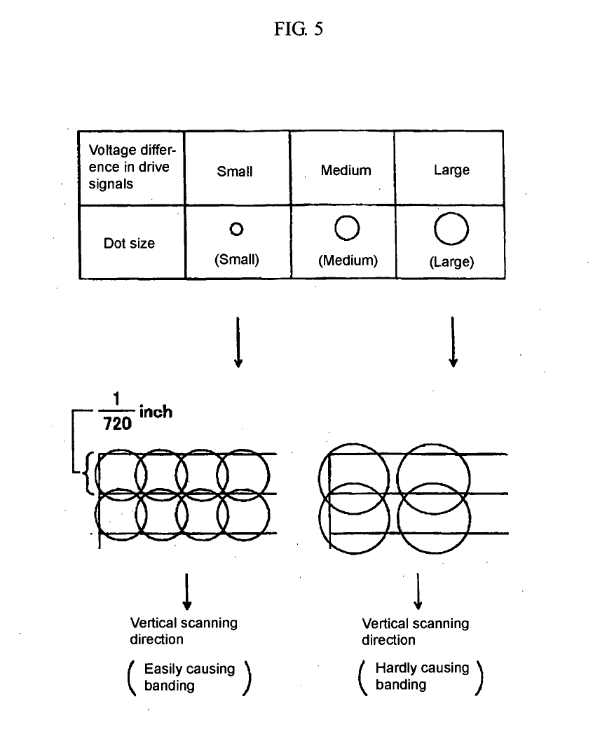

The upper part of FIG. 5 shows relationship between a voltage difference in drive signals output from the head drive section 26a and a dot size of ink ejected from the print head. The printer 20 is capable of printing using a dot size selected from a plurality of types of dot sizes. Specifiable dot sizes are large, medium, and small. Here, a small voltage difference decreases the dot size to form small dots. A large voltage difference increases the dot size to form large dots. A medium voltage difference causes a medium dot size to form medium dots. The CPU 21 reads the selection information about dot sizes from the RAM 23. The CPU 21 then creates applied voltage data and outputs it to the ASIC 26 so as to form dots sized correspondingly to the selection information. This allows the head drive section 26a to generate a drive voltage pattern.

When an ink dot is formed on a medium, the dot diameter is generally larger than the vertical scanning interval. As shown in the lower part of FIG. 5, the diameter of small dots more approximates to the vertical scanning interval than the diameter of large dots. When small dots are formed, an erratically ejecting nozzle, if any, easily causes banding. On the other hand, when large dots are formed, an erratically ejecting nozzle, if any, hardly causes banding.

(2) Configuration Overview of the Printing Control Apparatus

In the PC 10, the BIOS is executed on the basis of the above-mentioned hardware. The OS and the APL are executed on a layer higher than the BIOS. The OS is installed with a display driver to control the CRT I/F 17, a printer driver to control the printer I/F 19, and the like. These drivers form part of the OS to execute various control processes. The APL exchanges data and the like with the hardware via the OS.

The printer driver contains the printing control program according to the present invention and is activated when the APL executes the print function. The printer driver is capable of bidirectional communication with the printer 20 via the printer I/F 19. The printer driver receives image data from the APL via the OS installed with the GDI (Graphics Device Interface) and the like. The printer driver converts the received image data to image data suitable for output to the printer 20. The printer driver then transmits the converted image data as a print job to the printer 20.

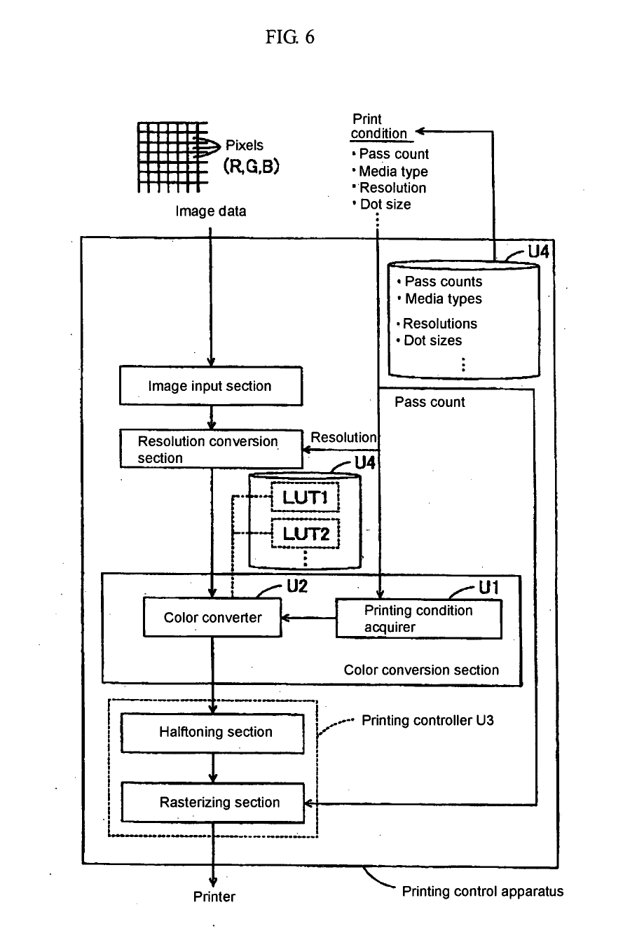

FIG. 6 schematically shows an overview configuration of the printing control apparatus implemented by the function of the above-mentioned printer driver.

The printer driver comprises various modules. The printer driver implements specified functions under control of a function control module (not shown). The printer driver concurrently provides control to print an image based on the image data. The function control module configures process sections in FIG. 6. An image input section supplies image data created by the APL via the GDI. The image data represents an image in multi-gradations using many dot matrix pixels. According to the embodiment, the following description assumes that image data comprises gradation data in 256 gradations assigned with gradation values from 0 to 255 correspondingly to red (R), green (G), and blue (B). Since image data to be input comprises pixels, gradation values for each pixel are assumed to be color components R, G, and B. Then, the gradation data for each pixel is represented as (R,G,B). The program can execute the printing control for various image data. For example, the printing control may be executed for image data such as YUV comprising brightness data, blue color difference data, and red color difference data.

A resolution conversion section converts a resolution of input image data comprising three RGB colors into a resolution suitable for printing on the printer 20. A color conversion section color-converts the resolution-converted image data into image data represented by gradation data comprising eight colors CMYKLcLmLkLLk for each pixel. Accordingly, after the color conversion, the gradation data for each pixel is represented as eight color component values (C, M, Y, K, Lc, Lm, Lk, LLk).

A halftoning section further converts the color-converted image data into image data represented by the presence or absence of dots. For example, the presence or absence of dots is indicated by four gradations corresponding to values 0 through 3 respectively assigned to the states of forming no dots, small dots, medium dots, and large dots. A rasterizing section sorts the image data in a sequence used for the printer 20 based on the pass count for printing a line of image and transmits the image data to the printer 20. Based on the converted image data, the printer 20 forms ink dots on the medium to print a color image corresponding to the image data.

In general, the printing control apparatus comprises means U1 through U4 to be described below.

Means U1 and U2 are included in the color conversion section. A printing controller U3 comprises a half toning section and a rasterizing section. Storage means U4 comprises the hard disk driver HDDRV and the HD 14 as mentioned above.

The printing condition acquirer U1 acquires print conditions specified for the input image data out of a plurality of predetermined print conditions concerning the possibility of banding on printouts from the printer 20. The print conditions include: the pass count such as 2-pass or 4-pass to print a line of image; types of media to print images; the resolution such as 720×360 dpi or 1440×720 dpi for printing; and the dot size such as large, medium, or small dots to be formed. The printing control apparatus is previously provided with a plurality of conditions for each type of the print conditions. The provided conditions are stored in the HD 14. The plurality of conditions for each type are print conditions that affect the possibility of banding on printouts.

The resolution to print images is the same as that used for the resolution conversion section. Accordingly, the printing condition acquirer U1 may acquire a resolution acquired by the resolution conversion section. The pass count is the same as that used for the rasterizing section. Accordingly, the rasterizing section may use a pass count acquired by the printing condition acquirer U1.

There is a plurality of color conversion modes with varied usage ratios between three chromatic inks LcLmY and two light black inks LkLLk. A color converter U2 color-converts image data using a color conversion mode corresponding to the acquired print condition as mentioned above. At this time, the color converter U2 references a color conversion table called a LUT (look-up table) that specifies the correspondence between image data before and after the color conversion. In this manner, the color converter U2 sequentially color-converts gradation data for pixels constituting the image data. There is provided a plurality of LUTs correspondingly to the plurality of print conditions as mentioned above. The HD 14 stores the LUTs. That is to say, the LUTs are provided correspondingly to the color conversion modes according to the present invention. The color converter U2 references the LUT corresponding to the acquired print condition for color conversion.

The LUT according to the embodiment is an information table that maintains correspondence between gradation values of 256 RGB gradations and gradation values 0 to 255 corresponding to 256 gradations for each of eight colors CMYKLcLmLkLLk. The following description assumes that interpolation operations are used and the LUT comprises a large amount of data corresponding to 17×17×17 grid points. Of course, various gradations may be available in addition to 256 gradations. The number of gradations for gradation values may differ before and after the conversion. The converted image data represents an image using dot matrix pixels in multiple gradations. Increasing a gradation value also increases each component of the above-mentioned eight colors. Accordingly, increasing a gradation value also increases the density of dots formed on a medium.

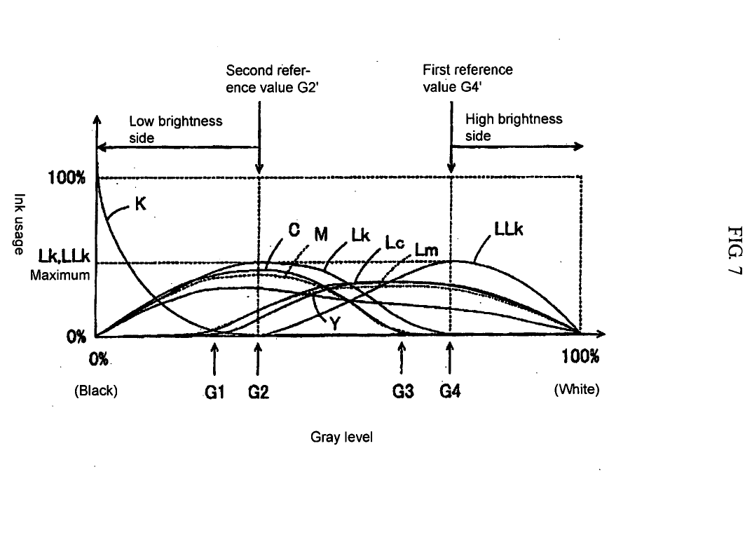

It is difficult to reproduce neutral gray (R=G=B) using only CMYLcLm inks. Accordingly, the LUT is created so as to replace part or all of CMYLcLm inks with the Lk or LLk ink. FIG. 7 shows an example of the correspondence provided by the LUT for the gray level (R=G=B). The abscissa indicates relative gradation values for the gray level, i.e., a gradation amount representing achromatic components. The direction to the left of the abscissa decreases the RGB values to approximate black. The direction to the right of the abscissa increases the RGB values to approximate white. The ordinate indicates ink usages (relative values) of the above-mentioned eight colors of inks. When the gray level is 0% (R=G=B=0), the usage of the K ink is assumed to be 100% and the usages of the CMYLcLmLkLLk inks are assumed to be 0%. Increasing the gray level decreases the usage of K and increases the usages of CMY and Lk. At gray level G1, the usage of K becomes almost 0%. The usage of Y almost reaches the maximum and starts decreasing. The usages of LcLm start increasing from 0%. At gray level G2, the usage of Lk reaches the maximum and starts decreasing. The usages of CM also reach almost the maximum and start decreasing. The usage of LLk starts increasing from 0%. At gray level G3, the usages of CM become 0%. At gray level G4, the usages of LcLm almost reach the maximum and start decreasing. The usage of Lk becomes 0%. The usage of LLk reaches the maximum and starts decreasing. When the gray level reaches 100% (R=G=B=255), the usages of YLcLmLLk also become 0%.

The LUT as mentioned above is used to color-convert the image data. The printer is then used to print an image based on the color-converted image data. Part or all of the chromatic inks are replaced by the light black inks to form dots. As a result, it is possible to decrease influences such as variations in the ink ejection amounts of various chromatic inks. The gray balance can be improved. The image quality can be improved with respect to the metamerism. Specifically, part or all of the LcLmY inks are replaced by the LkLLk inks to form dots. The gray balance and the like can be improved also in a highlight area with high brightness.

However, replacing various chromatic inks with the light black inks decreases ink dots formed on a printout medium, easily causing the banding. In order to prevent banding, the LUT is created according to the following considerations. One consideration is to determine the usage ratio between chromatic inks and light black inks in accordance with a print condition of easily causing the banding out of various print conditions. Another consideration is to specify the correspondence before and after the image data conversion.

The embodiment in advance creates a plurality of LUTs that specify the correspondence between image data before and after the color conversion for the respective print conditions. The purpose is to increase the usage ratio of the light black inks under a condition of hardly causing the banding and improve the gray balance and the like. To prevent the banding, the LUTs are designed to form dots by changing usage ratios between the chromatic inks and the light black inks. The LUTs are changed in accordance with the print conditions to produce images with excellent image quality by preventing the banding. The light black inks are lighter than the K ink. Even if dots decrease after replacing the chromatic inks with the light black inks, the granularity of dots is unremarkable. Also in this respect, it is possible to produce images with excellent image qualities.

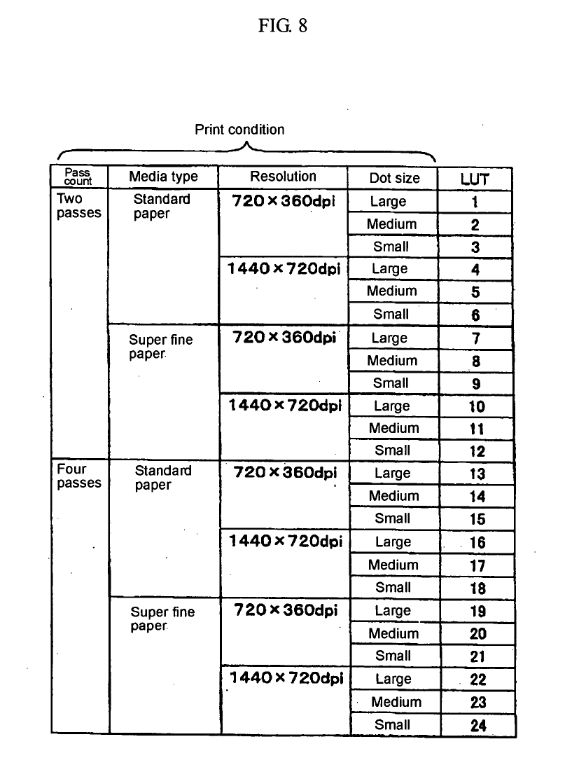

As shown in FIG. 8, the LUTs are predetermined according to different types of pass counts, media, resolutions, and dot sizes. The LUTs are stored in the HD 14 along with combinations of the print conditions. The types of pass counts, media, resolutions, and dot sizes are predetermined print conditions that affect the possibility of banding on printouts from the printer. Each LUT is configured to be an information table. The LUT is referenced during color conversion in a color conversion mode with a changed usage ratio between the LcLmY inks and the LkLLk inks for a combination of the print conditions. The LUTs are given different numbers for convenience's sake. However, it is unnecessary to use completely different LUTs for the print conditions. The same type of LUT may be used for different print conditions.

The storage means U4 stores not only the above-mentioned print conditions, but also the color conversion modes corresponding to the print conditions. Here, the color conversion modes are given modified usage ratios between the chromatic inks and the light black inks.

The usage of the light black inks is specified as follows.

Let us assume that a gradation value indicating achromatic components is set to a high-brightness side from a first reference value G4′ corresponding to the specified reference amount G4 (relative value). Here, the high-brightness side corresponds to the gray level ranging from G4 to 100%. In this case, the system uses only the LLk ink having a relatively small depth out of the light black inks. While the image data comprises pixels, the LUT uses a gradation value to represent achromatic components of pixels targeted for the color conversion. When the gradation value changes from the reference value G4′ to the high-brightness side, the LUT is assigned a color conversion mode configured to use only the LLk ink out of two inks LkLLk.

Let us assume that a gradation value indicating achromatic components is set to a low-brightness side from a second reference value G2′ corresponding to the specified reference amount G2 (relative value). Here, the low-brightness side corresponds to the gray level ranging from 0% to G2. In this case, the system uses only the Lk ink having a relatively large depth out of the light black inks. It should be noted that the reference amount G2 is settled toward the low-brightness side away from the reference amount G4. While the image data comprises pixels, the LUT uses a gradation value to represent achromatic components of pixels targeted for the color conversion. When the gradation value changes from the reference value G2′ to the low-brightness side, the LUT is assigned a color conversion mode configured to use only the Lk ink out of two inks LkLLk.

The LUT is assigned the color conversion mode configured to use only the LLk ink out of the two inks LkLLk in an area deviated from the gray axis of R=G=B in the RGB color space comprising RGB colors. This mode is also specified when a gradation amount representing achromatic components changes from a specified reference amount to the high-brightness side. For example, let us use R, G, and B to represent gradation values for gradation data comprising RGB. Further, let us use gradation value N to represent a gradation amount indicative of achromatic components in targeted pixels. Then, an average value for R, G, and B can be assumed to be gradation value N. Under the condition of N>G4′ (or N≧G4′), the LUT just needs to define a color conversion mode configured to use only the LLk ink out of the two types of light black inks.

A gradation amount indicative of achromatic components may change from another specified reference amount to the low-brightness side in the area deviated from the gray axis. Also in this case, the LUT is assigned the color conversion mode configured to use only the Lk ink out of the two inks LkLLk. Likewise, an average value for R, G, and B can be assumed to be gradation value N. Under the condition of N<G2′ (or N≦G2′), the LUT just needs to be assigned the color conversion mode configured to use only the Lk ink out of the two types of light black inks.

Here, the reference values G4′ and G2′ may be function values G4′ (R, G, B) and G2′ (R, G, B) that vary with differences in the RGB gradation values. Alternatively, the reference values G4′ and G2′ may be specified values that are fixed independently of differences in the RGB gradation values.

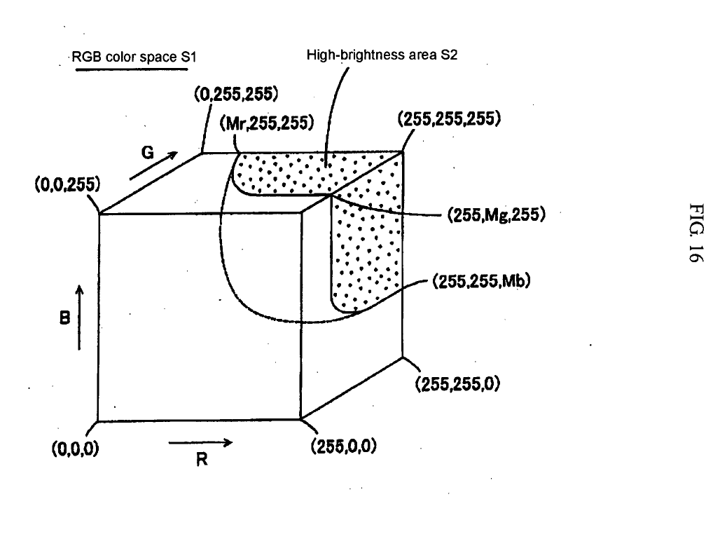

As will be described in FIG. 16, a high-brightness area S2 may be finely provided in an RGB color space S1. In the area S2, it may be preferable to specify the color conversion mode configured to use only the Lk ink out of the two inks LkLLk.

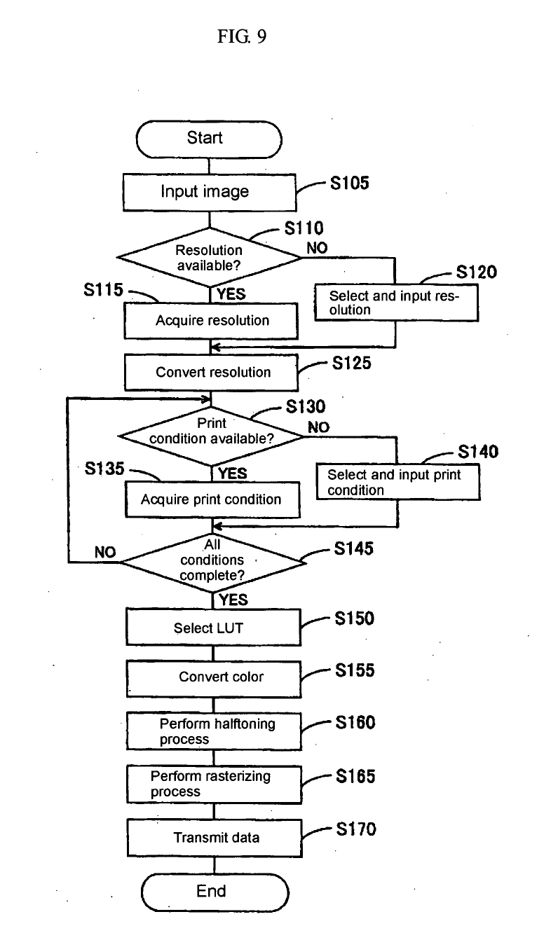

FIG. 9 is a flowchart showing a printing control process using the above-mentioned LUTs. The CPU 11 of the PC executes this flow.

The APL has a print function. This print function for the APL is used to select a print execution menu to be displayed on the display 17a. At this time, the image input section acquires RGB image data at step S105. The word “step” is omitted from the description to follow. The image data need not be read all at a time, and may be read partially. When image data is called from another APL, it may be preferable to exchange only pointers to buffer areas used for exchanging data. The image data may be supplied with information for selecting the pass count to print an image, the media type, the resolution, and the dot size. In such case, the process acquires the supplied information.

The resolution conversion section then acquires the resolution for printing on the printer 20. The input image data is supplied with the information for setting the resolution. In addition, it is determined whether or not the resolution corresponding to the information belongs to the plurality of types of resolutions stored in the HD 14 (S110). If the condition is true, the process acquires the resolution corresponding to the information (S115), and then proceeds to S125. If the condition is false, the process reads the types of resolutions stored and displays them on a resolution selection screen (not shown). The screen has a field to select the resolution. A user can select any of the resolutions by means of an input operation. The process accepts the input operation, acquires the selected resolution (S120), and then proceeds to S125. In this manner, the user can specify the resolution for the image data by means of the input operation. Of course, it may be preferable to acquire the default resolution (e.g., 720×360 dpi).

In this manner, the process acquires the resolution specified for the input image data.

At S125, a resolution conversion process is performed to convert the acquired resolution for the image data into a resolution for printing on the printer 20. When the acquired resolution for the image data is high, the process converts the resolution by eliminating data at a specified ratio. When the acquired resolution for the image data is low, the process converts the resolution by interpolating the image data according to the linear interpolation, for example.

Then, the color conversion section acquires various print conditions affecting the possibility of banding. While the print conditions contains the resolutions, the color conversion section uses the resolution acquired at S110. The following process is sequentially performed to acquire the pass count, the media type, and the dot size for each type of these print conditions.

The process determines whether or not the image data is provided with the information for setting the type of print condition to be acquired. In addition, the process determines whether or not the print condition corresponding to the information belongs to the print conditions stored in the HD 14 (S130). If it is determined that the print condition corresponds to any of the stored print conditions, the process acquires the print condition corresponding to the information (S135), and then proceeds to S145. If it is determined that the print condition does not correspond to any of the stored print conditions, the process reads the stored print conditions and displays a print interface screen (not shown). The screen has a field to select the print mode. A user can select any of the print conditions by means of an input operation. The process accepts the input operation, acquires the selected print condition (S140), and then proceeds to S145. In this manner, the user can specify the print conditions for the image data by means of the input operation. Of course, it may be preferable to acquire the default pass count (e.g., 2-pass), the default media type (e.g., standard paper), and the default dot size (e.g., large dots).

At S145, it is determined whether or not the process acquires the print conditions specified for the image data out of all the print conditions. If there is the type of print condition not acquired, the process returns to S130. If all the types of print conditions are acquired, the process proceeds to S150.

In this manner, the process at S130 through S145 constitutes the printing condition acquirer.

At S150, the process selects an LUT corresponding to the print condition out of the LUTs and specifies the color conversion mode. The LUTs are provided correspondingly to the print conditions. This process will be described in more detail later. When selecting an LUT, the LUT data may be all read from the HD 14 to the RAM 13 at a time or may be read partially. Further, it may be preferable to only determine a pointer to an area on the HD.

The process references the LUT that is used to change a usage ratio between the LcLmY and LkLLk inks correspondingly to the print conditions. The process then performs a color conversion process that converts the RGB image data into image data corresponding to each of the eight colors of inks (S155). With respect to pixels constituting the image data, the process sequentially moves targeted pixels whose gradation data needs to be color-converted. At the same time, the process references the selected LUT. The process acquires gradation values for CMYKLcLmLkLLk corresponding to the gradation values for RGB of the targeted pixels. Consequently, the process assumes the gradation data comprising these gradation values to be gradation data after the color conversion. The LUT to be referenced is selected so as to change the usage ratio between the chromatic inks and the light black inks. There are provided the color conversion modes with changed usage ratios between both types of inks corresponding to the print conditions. Of these color conversion modes, the process uses the color conversion mode compliant with the acquired print condition to color-convert the image data.

In this manner, the process at S150 through S155 constitutes the color converter.

Thereafter, the halftoning section sequentially moves the targeted pixels whose data need to be converted. In this manner, the halftoning section performs a specified halftoning process for gradation data of all the pixels. While the image data represents an image with dot matrix pixels in multi-gradations, the process converts that image data into image data represented by the presence or absence of dot formation (S160).

The rasterizing section performs a rasterizing process to rearrange the image data represented by the presence or absence of dot formation (S165). To do this, the rasterizing section uses the pass count acquired at S135 or S140 in consideration for the dot formation sequence of the printer 20. The process transmits the finally acquired image data along with the selection information about the pass count, the resolution, and the dot size acquired at S135 or S140 to the printer (S170), and then terminates the flow. The printer 20 receives the selection information and the image data. The printer 20 then drives the print head to form ink dots corresponding to the pass count, the resolution, and the dot size on a printout medium. As a result, the printer prints a color image corresponding to the image data from the APL on the medium.

In this manner, the process at S160 through S170 configures the printing controller that provides the printing control for the printer based on the color-converted image data.

(3) Detailed Processes of the Printing Control Apparatus

The following describes the detail of the LUT selection process performed by the printing control apparatus.

As shown in FIG. 8, a plurality of LUTs are stored in the HD 14 correspondingly to a plurality of print conditions. For example, let us assume that the acquired information shows the pass count to be “two passes”, the media type to be “standard paper”, the resolution to be “720×360 dpi”, and the dot size to be “large”. In this case, the process selects LUT “1” from the HD 14. When only the pass count is changed to “four passes”, the process selects LUT “13”.

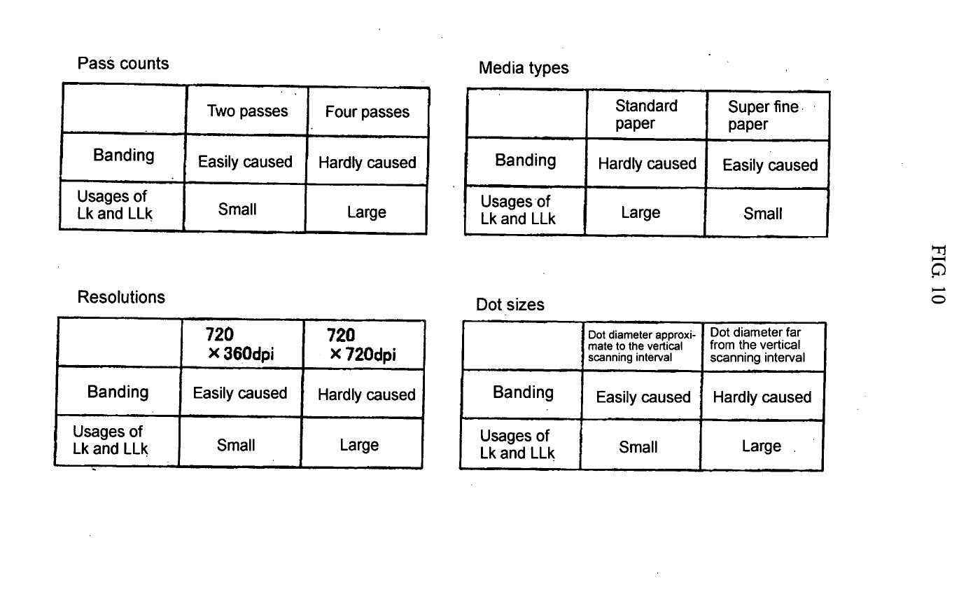

The LUTs are created for the respective print conditions in consideration for the possibility of banding on printouts from the printer 20. As mentioned above, decreasing the pass count generally increases the possibility of banding. As shown in FIG. 10, the correspondence before and after the image data conversion is specified with respect to the pass count as follows. The usage ratio of the LkLLk inks to the LcLmY inks is set to be smaller for two passes than for four passes. In other words, the usage ratio thereof is set to be larger for four passes than for two passes. That is to say, increasing the pass count decreases the possibility of banding even if the usage ratio of the LkLLk inks is increased. In such case, the usage ratio of the LkLLk inks is increased by giving a preference to the gray balance to print an image with improved image quality and less remarkable granularity of dots.

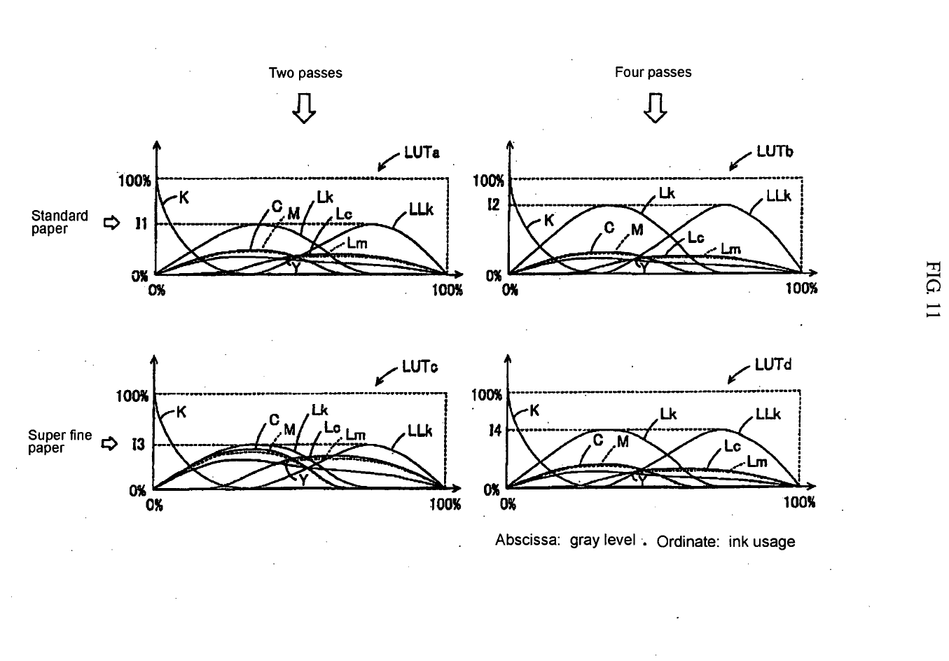

FIG. 11 exemplifies gray-level correspondences represented by the LUTs created in accordance with the pass counts. These LUTs are all conditioned to be 720×360 dpi and large dots. LUTa and LUTc on the left are conditioned to two passes. LUTb and LUTd on the left are conditioned to four passes. LUTa and LUTb on the top are conditioned to the standard paper. LUTc and LUTd on the bottom are conditioned to the super fine paper.

As shown in FIG. 11, when the standard paper is used as the media type, I2 is larger than I1, where I2 is the maximum usage (e.g., approximately 85%) of LkLLk inks for four passes and I1 is the maximum usage (e.g., approximately 60%) of LkLLk inks for two passes. When the super fine paper is used as the media type, I4 is larger than I3, where I4 is the maximum usage of LkLLk inks for four passes and I3 is the maximum usage of LkLLk inks for two passes.

Let us assume that the pass count is relatively small, i.e., two passes, the resolution is 720×360 dpi, and the dot size is large. In this case, the LUT selection process selects LUTa or LUTc. The color conversion process converts colors by referencing LUTa or LUTc that specifies a smaller usage ratio of the LkLLk inks to the LcLmY inks. On the other hand, let us assume that the pass count is relatively large, i.e., four passes without changing the resolution and the dot size. In this case, the LUT selection process selects LUTb or LUTd. The color conversion process converts colors by referencing LUTb or LUTd that specifies a larger usage ratio of the LkLLk inks to the LcLmY inks. Further, decreasing the pass count may decrease the usage ratio of the KLk inks to the CMY inks. Increasing the pass count may increase usage ratio of the KLk inks to the CMY inks. The same applies to the other similar cases. In this manner, the color conversion uses the color conversion mode corresponding to the pass count out of the color conversion modes with varied usage ratios between the LcLmY inks and the LkLLk inks. The printer 20 acquires not only the color-converted, halftoned, and rasterized image data, but also the selection information about the print conditions. The printer 20 increases the usage ratio of the LkLLk inks for a larger pass count to produce an image printout corresponding to the image data. That is to say, the pass count 4 hardly causes banding and can increase the usage ratio of the LkLLk inks compared to the prior art. This can decrease influences such as variations in the ink ejection amounts of various chromatic inks to improve the gray balance and the like. The image quality can be improved with respect to the metamerism.

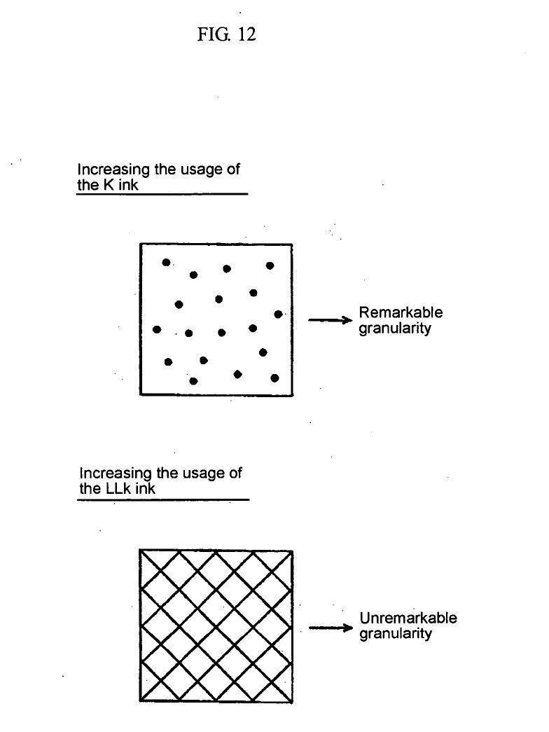

The upper part of FIG. 12 shows that the chromatic inks are replaced by the K ink. While the ink becomes deeper, the number of dots decreases, making the granularity more remarkable. By contrast, the present invention replaces the chromatic inks with the LkLLk inks that are lighter than the K ink. Even if the formed dots decrease, the dot granularity is unremarkable as shown in the lower part of FIG. 12.

As shown in FIG. 7, gradation data for respective pixels is sequentially color-converted so as to use only the LLk ink out of LkLLk when the gradation value N changes from the specified reference value G4′ to the high-brightness side. In this case, the gradation value N represents achromatic components in the pixels to be color-converted. A bright portion of the image uses only the LLk ink out of the Lk and LLk inks since the LLk ink is relatively lighter. As shown in the lower part of FIG. 12, the chromatic inks are replaced by the LLk ink at the bright portion. This can more reliably make the dot granularity less remarkable in the high-brightness area. Recently, there is an increasing demand for images of more improved image quality. The printing control apparatus is especially effective for producing images of the excellent image quality with the improved granularity.

The gradation data for respective pixels is sequentially color-converted so as to use only the Lk ink out of LkLLk when the gradation value N changes from the specified reference value G2′ to the low-brightness side. Also in this case, the gradation value N represents achromatic components in the pixels to be color-converted. A dark portion of the image uses only the Lk ink out of the Lk and LLk inks since the Lk ink is relatively deeper. The Lk ink can effectively represent the low-brightness area that cannot be represented by the lighter LLk ink, making it possible to produce images with the improved image quality. As will be discussed below, the same is true when changing the ink usage ratio in accordance with the media type, the resolution, and the dot size.

As mentioned above, it is possible to change the usage ratio between the chromatic inks and the light black inks in accordance with the pass count for printing a line of image based on the image data. This makes it possible to acquire the appropriate image quality with less remarkable dot granularity according to the pass count by preventing the banding.

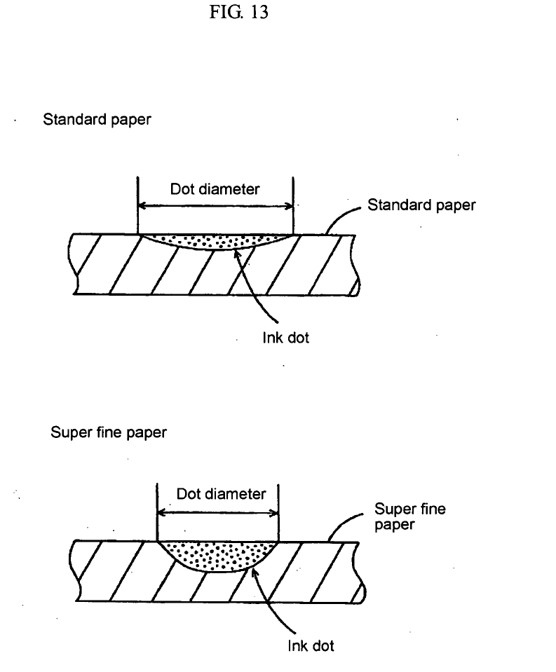

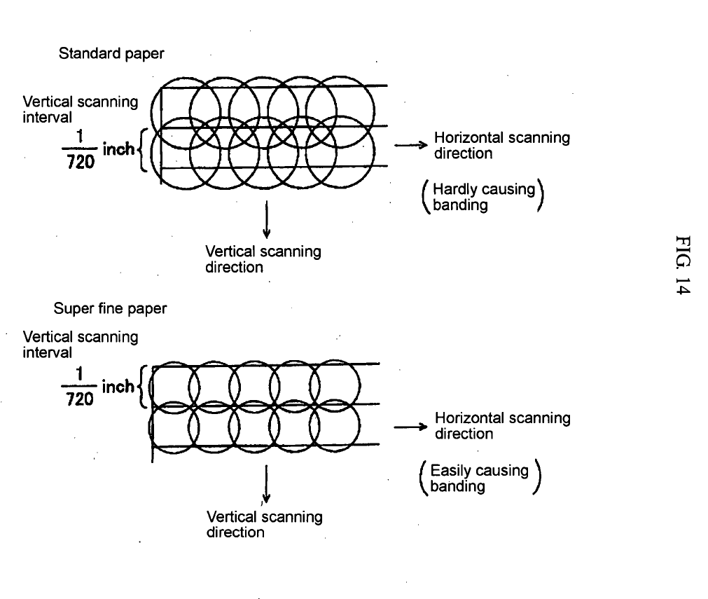

As shown in FIG. 10, the correspondence before and after the image data conversion is specified with respect to the media type as follows. The usage ratio of the LkLLk inks to the LcLmY inks is set to be larger for the standard paper than for the super fine paper. In other words, the usage ratio thereof is set to be smaller for the super fine paper than for the standard paper. The reason is that the standard paper hardly causes banding and the super fine paper easily causes banding. The ink less easily spreads on the surface of the super fine paper than the standard paper. When the same amount of ink (e.g., LLk ink) is used for ejection to form dots on media, an ink dot diameter becomes smaller on the super fine paper than on the standard paper as shown in FIG. 13. The upper part of FIG. 13 shows a sectional view of an ink dot formed on the standard paper as a printout medium. The lower part of FIG. 13 shows a sectional view of an ink dot formed on the super fine paper as a printout medium. As shown in FIG. 14, the standard paper increases an area per dot formed on the media compared to the super fine paper.

Generally, the diameter of dots formed on media is larger than the vertical scanning interval. The diameter of dots formed on the super fine paper more approximate to the vertical scanning interval than that of dots formed on the standard paper. Accordingly, an erratically ejecting nozzle, if any, easily causes banding on the super fine paper. By contrast, the standard paper is hardly subject to banding even if the usage ratio of the LkLLk inks is increased. Let us suppose that the diameter of ink dots formed on media is larger than the vertical scanning interval. When the media type relatively increases a dot diameter without changing the ejection amount, the gray balance is given a preference to increase the usage ratio of the LkLLK inks. This makes it possible to print images with less remarkable dot granularity and more excellent image quality.

As shown in FIG. 11, when the pass count 2 is used, I3 is smaller than I1, where I3 is the maximum usage (e.g., approximately 45%) of LkLLk inks for the super fine paper as the media type and I1 is the maximum usage (e.g., approximately 60%) of LkLLk inks for the standard paper as the media type. When the pass count 4 is used, I4 is smaller than I2, where I4 is the maximum usage of LkLLk inks for the super fine paper as the media type and I2 is the maximum usage of LkLLk inks for the standard paper as the media type.

Let us assume that the media type is the standard paper causing a relatively large ink dot diameter, the resolution is 720×360 dpi, and the dot size is large. In this case, the LUT selection process selects LUTa or LUTb. The color conversion process converts colors by referencing LUTa or LUTb that specifies a larger usage ratio of the LkLLk inks to the LcLmY inks. By contrast, let us assume that the media type is the super fine paper causing a relatively small ink dot diameter without changing the resolution and the dot size. In this case, the LUT selection process selects LUTc or LUTd. The color conversion process converts colors by referencing LUTc or LUTd that specifies a smaller usage ratio of the LkLLk inks to the LcLmY inks. In this manner, the color conversion uses the color conversion mode corresponding to the media type out of the color conversion modes with varied usage ratios between the LcLmY inks and the LkLLk inks. The printer 20 acquires not only the color-converted, halftoned, and rasterized image data, but also the selection information about the print conditions. It is assumed that the diameter of ink dots formed on the medium is larger than the vertical scanning interval. With the ejection amount unchanged, as the diameter of ink dots formed on the medium becomes larger than the vertical scanning interval, the usage ratio of the LkLLk inks is increased to produce an image printout corresponding to the image data. Since the standard paper is the type of media hardly causing the banding, it is possible to increase the usage ratio of the LkLLk inks compared to the prior art. This can decrease influences such as variations in the ink ejection amounts of various chromatic inks to improve the gray balance and the like.

Accordingly, it is possible to change the ink usage ratio in accordance with the types of media where an image is printed based on the image data. This makes it possible to acquire the appropriate image quality with less remarkable dot granularity according to the media type by preventing the banding.

Further, as shown in FIG. 10, the correspondence before and after the image data conversion is specified with respect to the resolution as follows. The usage ratio of the LkLLk inks to the LcLmY inks is set to be smaller for the resolution 720×360 dpi than for 720×720 dpi. In other words, the usage ratio thereof is set to be larger for 720×720 dpi than for 720×360 dpi. The reason is that, as shown in FIG. 4, the resolution of 720×360 dpi generates striped gaps to easily cause the banding; the resolution of 720×720 dpi scarcely generates striped gaps to hardly cause the banding. Compared to the resolution of 720×360 dpi, the resolution of 720×720 dpi causes no banding even if the usage ratio of the LkLLk inks is increased. When the high resolution is used, the usage ratio of the LkLLk inks is increased by giving a preference to the gray balance to print an image with improved image quality and less remarkable granularity of dots.

When the pass count is 2 and the dot size is large, the resolution of 720×720 dpi uses almost the same LUT as LUTb or LUTd used for four passes. A more detailed description follows with reference to FIG. 11. When the media type is the standard paper, I2 is greater than I1, where I2 is the maximum usage of LkLLk inks for the resolution of 720×720 dpi and I1 is the maximum usage of LkLLk inks for the resolution of 720×360 dpi. The same applies to the super fine paper.

Let us assume that the resolution is relatively low, i.e., 720×360 dpi, the pass count is 2, and the dot size is large. In this case, the LUT selection process selects LUTa or LUTc. The color conversion process converts colors by referencing LUTa or LUTc that specifies a smaller usage ratio of the LkLLk inks to the LcLmY inks. On the other hand, let us assume that the resolution is relatively high, i.e., 720×720 dpi without changing the pass count and the dot size. In this case, the LUT selection process selects LUTb or LUTd. The color conversion process converts colors by referencing LUTb or LUTd that specifies a larger usage ratio of the LkLLk inks to the LcLmY inks. In this manner, the color conversion uses the color conversion mode corresponding to the resolution out of the color conversion modes with varied usage ratios between the LcLmY inks and the LkLLk inks. The printer 20 acquires not only the color-converted, halftoned, and rasterized image data, but also the selection information about the print conditions. The printer 20 increases the usage ratio of the LkLLk inks for a higher resolution to produce an image printout corresponding to the image data. That is to say, the resolution of 720×720 dpi hardly causes banding and can increase the usage ratio of the LkLLk inks compared to the prior art. This can decrease influences such as variations in the ink ejection amounts of various chromatic inks to improve the gray balance and the like.

Accordingly, it is possible to change the ink usage ratio in accordance with the resolution for printing. This makes it possible to acquire the appropriate image quality with less remarkable dot granularity according to the resolution by preventing the banding.

Further, as shown in FIG. 10, the correspondence before and after the image data conversion is specified with respect to the dot size as follows. The usage ratio of the LkLLk inks to the LcLmY inks is set to be smaller for small dots according to the embodiment when the diameter of an ink dot formed on media approximates to the vertical scanning interval of the printer 20. The usage ratio of the LkLLk inks to the LcLmY inks is set to be larger for large dots according to the embodiment when the diameter of an ink dot formed on media is distant from the vertical scanning interval of the printer 20. The reason is that, as shown in FIG. 5, the small dot diameter more approximates to the vertical scanning interval than the large dot diameter. Forming small dots easily cause the banding. On the other hand, forming large dots hardly causes the banding even if the usage ratio of the LkLLk inks is increased. It is assumed that the diameter of an ink dot formed on media is larger than the vertical scanning interval. When the large dot size is used, the usage ratio of the LkLLk inks is increased by giving a preference to the gray balance to print an image with improved image quality and less remarkable granularity of dots.

Let us assume that the pass count is 4 and the resolution is 720×360 dpi. When the dot diameter is larger than the vertical scanning interval, the small dot size uses almost the same LUT as LUTa or LUTc used for two passes. A more detailed description follows with reference to FIG. 11. When the media type is the standard paper, I2 is greater than I1, where I2 is the maximum usage of LkLLk inks for the large dot size and I1 is the maximum usage of LkLLk inks for the small dot size. The same applies to the super fine paper.

Let us assume that the dot size is small, the pass count is 4, and the resolution is 720×360 dpi. In this case, the LUT selection process selects LUTa or LUTc. The color conversion process converts colors by referencing LUTa or LUTc that specifies a smaller usage ratio of the LkLLk inks to the LcLmY inks. On the other hand, let us assume that the dot size is large when the dot diameter is larger than the vertical scanning interval, without changing the pass count and the resolution. In this case, the LUT selection process selects LUTb or LUTd. The color conversion process converts colors by referencing LUTb or LUTd that specifies a larger usage ratio of the LkLLk inks to the LcLmY inks. In this manner, the color conversion uses the color conversion mode corresponding to the dot size out of the color conversion modes with varied usage ratios between the LcLmY inks and the LkLLk inks. The printer 20 acquires not only the color-converted, halftoned, and rasterized image data, but also the selection information about the print conditions. The printer 20 increases the usage ratio of the LkLLk inks for a larger dot size to produce an image printout corresponding to the image data. That is to say, the large dot size hardly causes banding and can increase the usage ratio of the LkLLk inks compared to the prior art. This can decrease influences such as variations in the ink ejection amounts of various chromatic inks to improve the gray balance and the like.

Accordingly, it is possible to change the ink usage ratio in accordance with the dot size for printing. This makes it possible to acquire the appropriate image quality with less remarkable dot granularity according to the dot size by preventing the banding.

As mentioned above, there are predetermined print conditions that affect the possibility of banding on printouts from the printer. The color conversion mode is provided with the modified usage ratio between the chromatic inks and the light black inks in accordance with the print condition specified for the image data out of the predetermined print conditions. In such color conversion mode, the image data is color-converted and is provided with printing control. This makes it possible to produce an image with excellent image quality and less remarkable dot granularity by preventing the banding. The image quality can be improved especially in the high-brightness area so as to effectively prevent the banding and keep the dot granularity unremarkable. According to the present invention, the chromatic inks are replaced by the LkLLk inks. The chromatic inks comprise Lc (low-saturation cyan) ink, Lm (low-saturation magenta) ink, and Y (high-saturation yellow) ink. The LcLm inks provide higher brightness than the CM inks and generate many dots. Increasing the usage ratio of the light black inks can produce an image with more excellent image quality by preventing the banding.

Like the printer 20, the printing apparatus may be capable of color printing by using five types of chromatic inks. Since the low-saturation LcLm inks are provided, there is no need to use special color inks.

(4) Second Embodiment

Various configurations are available for the printing control apparatus and the printing apparatus capable of executing the printing control program according to the present invention.

For example, the printer may be combined with a computer or may be a special-purpose product that prints only monochrome images. The printer just needs to be capable of printing using a plurality of inks at least comprising chromatic ink and light black ink. The inks are available in various combinations of CMYLcLmLkLLk, LcLmYLkLLk, and the like without K. Instead of the LcLm inks, only Lc or Lm may be provided. The printer may be provided with dark yellow ink (Dy). The chromatic inks are not limited to CMYLcLm. The printer is not limited to using the piezo actuator that ejects ink to form dots. For example, it may be preferable to use a bubble printer that generates bubbles within an ink channel to eject ink. A plurality of inks may be supplied in separate ink cartridges or a single ink cartridge.

The APL and the like may implement the above-mentioned flows. Of course, in addition to execution in the PC, part or all of the flows may be executed in the printer or a special image output apparatus.

Depending on cases, the printer may be assigned pass counts, resolutions, and dot sizes without using the driver. A print condition acquisition function is used to acquire these pieces of information for printing on the printer. To acquire these print conditions, the print condition acquisition function may receive information about the pass count, the resolution, and the dot size from the printer. The same applies to the media sizes.

Image data to be input may be CMY-based data. In this case, a specified LUT can be referenced to color-convert the CMY-based image data into CYMKLcLmLkLLk-based image data. In addition, the C component may be separated into C and Lc with reference to a given LUT. The M component may be separated into M and Lm with reference to another LUT. Further, CMYLcLm may be color-converted into CMYKLcLmLkLLk with reference to yet another LUT. To input CMYLcLm-based image data, it just needs to reference a specified LUT for color conversion into CMYKLcLmLkLLk.

When the chromatic inks are replaced by the light black ink, banding easily occurs in a high-brightness area. For this reason, it may be preferable to perform the color conversion so as to change the usage ratio between the chromatic inks and the light black inks only in a specified high-brightness area of the color space capable of color conversion.

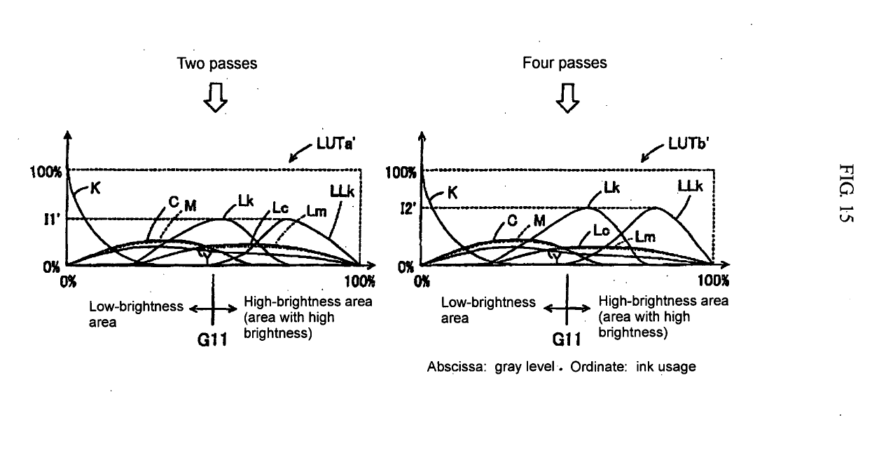

FIG. 15 exemplifies correspondences in the gray level concerning LUTs used for processes performed by the printing control apparatus according to the second embodiment of the present invention. Both LUTs correspond to the standard paper, 720×360 dpi, and the large dot. Of these LUTs, LUTa′ on the left corresponds to two passes; LUTb′ on the right corresponds to four passes.

According to LUTa′ and LUTb′, Lk is not used until the usage of the K ink almost becomes 0% even if the gray level increases from 0%. In a low-brightness area, the usage of each ink is the same independently of the pass counts as the print conditions. The correspondence for image data is defined so as to change the usage ratio between the LcLmY and LkLLk inks only in a specified high-brightness area. In this example, I2′ is greater than I1′, where I2′ is the maximum usage of LkLLk inks for the pass count 4 and I1′ is the maximum usage of LkLLk inks for the pass count 2.

The above-mentioned high-brightness area will be described in more detail with reference to FIG. 15. For example, the high-brightness area can range from G11 to 100% in terms of the gray level for a high-brightness side, where G11 is the specified reference amount (relative value). The range corresponds to relative gradation values for the gray level, i.e., the gradation amount to represent achromatic components. In FIG. 15, G11 is positioned to 50% but may be specified otherwise. Let us use R, G, and B to represent gradation values for gradation data comprising RGB before the color conversion in an area deviated from the gray axis of R=G=B in the RGB color space. Further, let us use gradation value N to represent a gradation amount indicative of achromatic components in targeted pixels for gradation data to be color converted. Then, an average value for R, G, and B can be assumed to be gradation value N. The high-brightness area can be assumed to be such an area in the RGB color space as to make the gradation value N to be greater than, or greater than or equal to a specified reference value G11′ corresponding to the reference amount G11. Only under the condition of N>G11′ (or N≧G11), the LUT just needs to define a color conversion mode that changes the usage ratio between the LcLmY and LkLLk inks.

As shown in FIG. 16, it maybe preferable to finely provide a high-brightness area S2 inside an RGB color space S1. The high-brightness area S2 is configured to contain R=G=B=255 points. Minimum values for the R, G, and B are defined to be greater than or equal to specified values Mr, Mg, and Mb. Of course, the high-brightness can be defined variously.

Let us assume that the pass count is 2, the media type is standard paper, the resolution is 720×360 dpi, and the dot size is large. In this case, the LUT selection process at S150 selects LUTa′. The color conversion process at S155 converts colors by referencing LUTa′ that specifies a smaller usage ratio of the LkLLk inks to the LcLmY inks. There are provided the color conversion modes with changed usage ratios between the LcLmY and LkLLk inks only for a specified high-brightness area in the RGB color space capable of color conversion. Of these color conversion modes, the process uses the color conversion mode compliant with the acquired print condition. The printer 20 acquires the color-converted, halftoned, and rasterized image data. The printer 20 increases the usage ratio of the LkLLk inks for a high-brightness area to print an image corresponding to the image data. Increasing the pass count also increases the brightness. That is to say, the pass count 4 hardly causes banding and can increase the usage ratio of the LkLLk inks compared to the prior art. This can decrease influences such as variations in the ink ejection amounts of various chromatic inks to improve the gray balance and the like. When the LcLmY inks are replaced by the LkLLk inks, the ink usage ratio can be changed only for the high-brightness area prone to banding. This makes it possible to produce an image with excellent image quality and less remarkable dot granularity by preventing the banding.

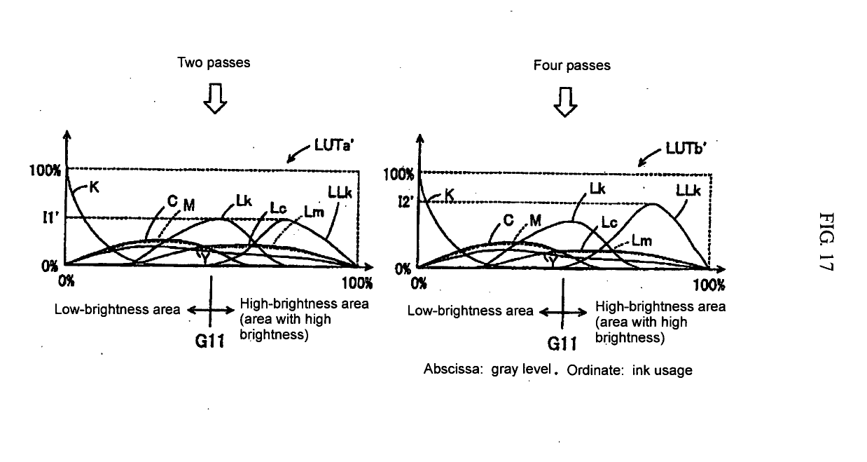

As shown in FIG. 17, the color conversion mode may be defined so as to change the usage ratio only for the LLk ink out of the Lk and LLk inks and not to change the usage ratio of the Lk ink. Then, there are provided color conversion modes to change the usage ratios between the LcLmY inks and only the LLk ink. The image data is color-converted using the color conversion mode corresponding to the acquired print condition out of the provided color conversion modes. Increasing the usage ratio of the light black inks increases the usage ratio of the LLk ink having a relatively small depth out of the Lk and LLk inks, making the dot granularity unremarkable. The image quality can be improved so as to effectively prevent the banding and keep the dot granularity more unremarkable.

(5) Third Embodiment

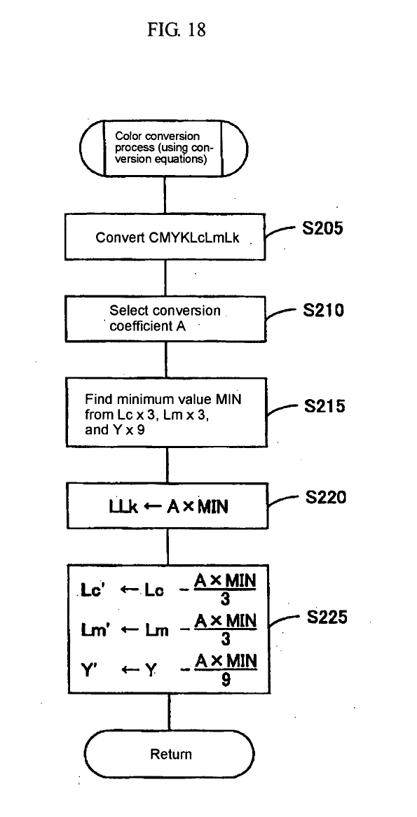

It may be preferable not to use the LUTs corresponding to the print conditions, but to use a specified conversion formula to change the usage ratios between chromatic inks and light black inks corresponding to the print conditions. FIG. 18 is a flowchart showing the color conversion process (using the conversion formula) performed by the printing control apparatus according to the third embodiment. The process flow in FIG. 18 is used in place of the LUT selection process and the color conversion process at S150 through S155 as mentioned above. The color conversion is performed assuming that the sum of ⅓ dots of Lc, ⅓ dots of Lm, and 1/9 dots of Y is equivalent to one dot of LLk. The following description uses C, M, Y, K, Lc, Lm, Lk, and LLk to represent the gradation values for CMYKLcLmLkLLk image data.

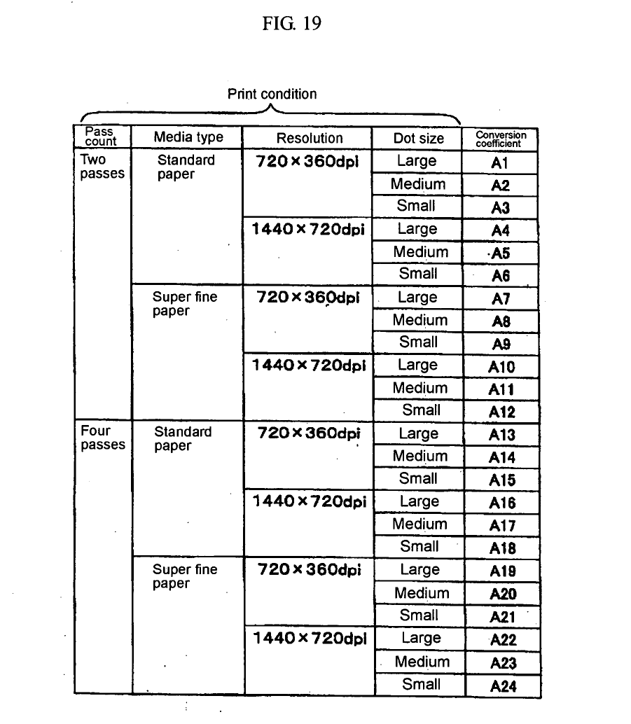

The printing control apparatus is supplied with image data, acquires the resolution, converts the resolution, acquires various print conditions (equivalent to S105 through S145 above), and then starts the process flow. The process first references a specified LUT stored in the HD 14 and color-converts the RGB image data into image data comprising seven colors CMYKLcLmLk (S205). The process then selects conversion factor A to be used for converting Lc, Lm, and Y into LLk based on the above-mentioned conversion formula (S210). As shown in FIG. 19, conversion factor A is provided for the respective pass counts media types, resolutions, and dot sizes. The value of conversion factor A is set to 0≦A≦1. Conversion factor A need not represent different values for all of the print conditions, but may represent the same value for different print conditions.

Conversion factor A is specified for the respective print conditions in consideration for the possibility of banding on printouts from the printer 20. For example, decreasing the pass count increases the possibility of banding. Conversion factor A is configured so as to decrease the conversion amount from the LcLmY inks to the LLk ink for two passes and increase the conversion amount to the LLk ink for four passes. When the print conditions are configured to be standard paper, 720×360 dpi, and large dot size except the pass count, conversion factors A1 and A13 are set to A1<A13. When the media type is super fine paper, conversion factors A7 and A19 are set to A7<A19.

The process acquires minimum value MIN from Lc×3, Lm×3, and Y×9 (S215). In this case, minimum value MIN becomes a maximum value that can be replaced by the LLk component.

As expressed in the following equation, multiply minimum value MIN is multiplied by conversion factor A to find LLk (S220).
LLk=A×MIN (1)

Assuming that Lc, Lm, and Y after the conversion are represented by Lc′, Lm′, and Y′, the processes uses the following equations to calculate Lc′, Lm′, and Y′ (S225), and then terminates the flow.
Lc′=Lc−A×MIN/3 (2)
Lm′=Lm−A×MIN/3 (3)
Y′=Y−A×MIN/9 (4)

The printer 20 acquires the color-converted, halftoned, and rasterized image data. The printer 20 then prints an image corresponding to the image data based on the usage ratio between the LcLmY inks and the LLk ink. The usage ratio is changed according to the print conditions. For example, the pass count 4 hardly causes banding and can increase the usage ratio of the LLk inks compared to the prior art. This can decrease influences such as variations in the ink ejection amounts of various chromatic inks to improve the gray balance and the like. As a result, it becomes possible to produce an image with excellent image quality and less remarkable dot granularity by preventing the banding.

It is possible to appropriately change the number of dots for Lc, Lm, and Y to be replaced by one dot of LLk as follows. At S215, the process finds reciprocals of the numbers of dots for Lc, Lm, and Y to be replaced by one dot of LLk and multiplies the reciprocals as coefficients by Lc, Lm, and Y, respectively, to find minimum values MIN. At S225, the process divides A×MIN for the above-mentioned equations (2) through (4) by the coefficients for Lc, Lm, and Y, and then subtracts the results from Lc, Lm, and Y before the conversion to calculate Lc′, Lm′, and Y′.

As mentioned above, the present invention according to various modes can produce an image with excellent image quality and less remarkable dot granularity by preventing the banding.

1. A printing control apparatus which receives image data representing an image with gradation data comprising many pixels, uses a plurality of inks containing chromatic ink and at least one light black ink, and performs color conversion into image data corresponding to each of said plurality of inks for a printing apparatus capable of printing to provide printing control, said printing control apparatus comprising:
a printing condition acquirer to acquire a print condition specified for said image data;
a color converter to color-convert said image data using a color conversion mode which belongs to a plurality of color conversion modes provided for said print condition and corresponds to a print condition acquired by said printing condition acquirer,
wherein said plurality of color conversion modes have different usage ratios between said chromatic ink and said light black ink; and
a printing controller to provide control for said printing apparatus to print an image corresponding to said color-converted image data.

2. The printing control apparatus according to claim 1,
wherein said printing condition acquirer acquires a print condition specified for said image data out of a plurality of predetermined print conditions which are provided as influencing possibility of banding on a printout produced by said printing apparatus.

3. The printing control apparatus according to claim 1,
wherein said light black ink comprises a first light black ink and a second light black ink having a smaller depth than the first light black ink; and
wherein said color converter sequentially color-converts gradation data for pixels constituting said image data so as to use only said second light black ink of said light black ink on a high-brightness side from a specified reference amount for gradation amounts representing achromatic components of pixels to be color-converted.

4. The printing control apparatus according to claim 1,
wherein said color converter color-converts said image data using a color conversion mode which belongs to a plurality of color conversion modes provided for said print condition and corresponds to a print condition acquired by said printing condition acquirer; and
wherein said plurality of color conversion modes have modified usage ratios between said chromatic ink and said light black ink.

5. The printing control apparatus according to claim 1,
wherein said color converter color-converts said image data using a color conversion mode which belongs to a plurality of color conversion modes and corresponds to a print condition acquired by said printing condition acquirer; and
wherein said plurality of color conversion modes have modified usage ratios between said chromatic ink and said light black ink for only a specified high-brightness area in a color space capable of color conversion.

6. The printing control apparatus according to claim 1,
wherein said printing apparatus prints a line of image corresponding to said image data using a pass count selected from a plurality of types of pass counts;
wherein said printing condition acquirer acquires a pass count specified for said image data as said print condition;
wherein said color converter color-converts said image data using a color conversion mode which belongs to a plurality of color conversion modes provided for said pass count and corresponds to a pass count acquired by said printing condition acquirer; and
wherein said plurality of color conversion modes have modified usage ratios between said chromatic ink and said light black ink.

7. The printing control apparatus according to claim 6,
wherein said color converter increases a usage ratio of said light black ink as said pass count increases.

8. The printing control apparatus according to claim 1,
wherein said printing condition acquirer acquires a media type specified for said image data as said print condition;
wherein said media type belongs to a plurality of types of media capable of printing an image corresponding to said image data;
wherein said color converter color-converts said image data using a color conversion mode which belongs to a plurality of color conversion modes provided for said media type and
wherein said plurality of color conversion modes have modified usage ratios between said chromatic ink and said light black ink.

9. The printing control apparatus according to claim 8,
wherein said color converter increases a usage ratio of said light black ink when a diameter of an ink dot formed on said media is larger than a vertical scanning interval of said printing apparatus and said media type causes a relatively large diameter of an ink dot formed in the same ejection amount.

10. The printing control apparatus according to claim 1,
wherein said printing apparatus prints an image corresponding to said image data at a resolution selected from a plurality of types of resolutions;
wherein said printing condition acquirer acquires a resolution specified for said image data as said print condition;
wherein said color converter color-converts said image data using a color conversion mode which belongs to a plurality of color conversion modes provided for said resolution and corresponds to a resolution acquired by said printing condition acquirer; and
wherein said plurality of color conversion modes have modified usage ratios between said chromatic ink and said light black ink.

11. The printing control apparatus according to claim 10,
wherein said color converter increases a usage ratio of said light black ink as said resolution increases.

12. The printing control apparatus according to claim 1,
wherein said printing apparatus prints an image corresponding to said image data using said plurality of inks in a dot size selected from a plurality of types of dot sizes;
wherein said printing condition acquirer acquires a dot size specified for said image data;
wherein said color converter color-converts said image data using a color conversion mode which belongs to a plurality of color conversion modes provided for said dot size and corresponds to a dot size acquired by said printing condition acquirer; and
wherein said plurality of color conversion modes have modified usage ratios between said chromatic ink and said light black ink.

13. The printing control apparatus according to claim 12,
wherein said color converter increases a usage ratio of said light black ink as said dot size increases when a diameter of an ink dot formed on said media is larger than a vertical scanning interval of said printing apparatus.

14. A printing control apparatus which receives image data representing an image with gradation data comprising dot-matrix pixels, uses a plurality of inks containing chromatic ink and at least one light black ink, and performs color conversion into image data corresponding to each of said plurality of inks for a printing apparatus capable of printing to provide printing control, said printing control apparatus comprising:
storage means for storing a plurality of predetermined print conditions provided as influencing possibility of banding on a printout produced by said printing apparatus and storing a plurality of color conversion modes corresponding to said plurality of print conditions,
wherein said plurality of color conversion modes have different usage ratios between said chromatic ink and said light black ink;
a printing condition acquirer which acquires a print condition specified for said image data out of said plurality of stored print conditions;
a color converter which specifies a color conversion mode corresponding to a print condition acquired by said printing condition acquirer out of said plurality of color conversion modes stored in said storage means and color-converts said image data using a specified color conversion mode; and
a printing controller which provides control for said printing apparatus to print an image corresponding to said color-converted image data.

15. A printing control method of receiving image data representing an image with gradation data comprising many pixels, using a plurality of inks containing chromatic ink and at least one light black ink, and performing color conversion into image data corresponding to each of said plurality of inks for a printing apparatus capable of printing to provide printing control, said printing control method comprising the steps of:
acquiring a print condition specified for said image data;
color-converting said image data using a color conversion mode which belongs to a plurality of color conversion modes provided for said print condition and corresponds to a print condition acquired by said step of acquiring a print condition,
wherein said plurality of color conversion modes have different usage ratios between said chromatic ink and said light black ink; and
providing control for said printing apparatus to print an image corresponding to said color-converted image data.

16. A printing control program product which allows a computer to implement functions of receiving image data representing an image with gradation data comprising many pixels, using a plurality of inks containing chromatic ink and at least one light black ink, and performing color conversion into image data corresponding to each of said plurality of inks for a printing apparatus capable of printing to provide printing control, said printing control program product implementing:
a print condition acquisition function to acquire a print condition specified for said image data;
a color conversion function to color-convert said image data using a color conversion mode which belongs to a plurality of color conversion modes provided for said print condition and corresponds to a print condition acquired by said print condition acquisition function,
wherein said plurality of color conversion modes have different usage ratios between said chromatic ink and said light black ink; and
a printing control function to provide control for said printing apparatus to print an image corresponding to said color-converted image data.
